(19) United States
(12) Patent Application Publication
(10) Pub. No.: US 2009/0200983 A1
(43) Pub. Date: Aug. 13, 2009

(54) Self-powering on-board power generation

(76) Inventors: David Dyer, Renton, WA (US); Gregory T. Janky, Sammamish, WA (US); Paul Willms, Everett, WA (US)

Correspondence Address: WAGNER BLECHER LLP, 123 WESTRIDGE DRIVE, WATSONVILLE, CA, 95076, US

(21) Appl. No.: 12/069,274

(22) Filed: Feb. 7, 2008

(51) Int. Cl. H02J 7/00

(52) U.S. Cl. 320/107

(57) ABSTRACT

An electric power generator for use in recharging a storage cell is provided. The electric power generator comprises an energy captor coupled with a shipping container, wherein the energy captor is configured to capture energy from a motion of the shipping container. An energy converter is coupled with the energy captor, wherein the energy converter is configured to generate electric power from the captured energy. The electric power generator further comprises a power projector configured to send the electric power to a storage cell.

### TECHNICAL FIELD

The technology relates to the field of power generation, and related translation endeavors.

### BACKGROUND

There are presently tens of millions of shipping containers world wide being transported by vessels such as trucks, trains or ships. Various types of electronic devices are attached to many of these containers, and perform functions such as geo-location and security monitoring. These on-board devices are typically powered by a portable power source, such as a battery, that is capable of being attached to a container.

The current state of technology of battery powered electronics, which may be coupled with or integrated within shipping containers, suffers from certain functional limitations. For instance, batteries generally tend to have relatively short life spans, are expensive when bought in mass quantities, and eventually must be recharged or replaced. Tracking tens of millions of shipping containers that are being transported throughout the world in order to recharge or replace batteries is expensive and inefficient. In addition, the frequent replacement of batteries contained in eighteen million containers presents environmental concerns associated with the discarded batteries.

### SUMMARY

This Summary is provided to introduce a selection of concepts that are further described below in the Detailed Description. This Summary is not intended to identify key or essential features of the claimed subject matter, nor is it intended to be used as an aid in determining the scope of the claimed subject matter.

An electric power generator for use in recharging a storage cell is provided. The electric power generator comprises an energy captor coupled with a shipping container, wherein the energy captor is configured to capture energy from a motion of the shipping container. An energy converter is coupled with the energy captor, wherein the energy converter is configured to generate electric power from the captured energy. The electric power generator further comprises a power projector configured to send the electric power to a storage cell.

### DESCRIPTION OF THE DRAWINGS

The accompanying drawings, which are incorporated in and form a part of this specification, illustrate embodiments of the technology for self-powering, on-board electricity generation, and together with the description, serve to explain principles discussed below:

FIG. 1 is a block diagram of an exemplary energy conversion and storage system in accordance with an embodiment of the present technology.

FIG. 2 is a diagram of an exemplary energy converter in accordance with an embodiment of the present technology.

FIG. 3 is a block diagram of an exemplary self-powering on-board power generation system in accordance with an embodiment of the present technology.

FIG. 4 is a diagram of an exemplary positional referencing schema in accordance with an embodiment of the present technology.

FIG. 5 is a diagram of an exemplary eccentric mass configuration in accordance with an embodiment of the present technology.

FIG. 6A is a diagram of a first exemplary electrical current induction configuration in accordance with an embodiment of the present technology.

FIG. 6B is a diagram of a second exemplary electrical current induction configuration in accordance with an embodiment of the present technology.

FIG. 7 is a diagram of an exemplary electronic processing system in accordance with an embodiment of the present technology.

FIG. 8 is a block diagram of an exemplary power generating configuration in accordance with an embodiment of the present technology.

FIG. 9 is a diagram of a multi-directional energy capture configuration in accordance with an embodiment of the present technology.

FIG. 10A is a side view of a diagram of an exemplary electroactive polymer actuation power generator in accordance with an embodiment of the present technology.

FIG. 10B is a side and cross-sectional view of a diagram of an exemplary electroactive polymer actuation power generator in accordance with an embodiment of the present technology.

FIG. 11 is a diagram of an exemplary pendulum module in accordance with an embodiment of the present technology.

FIG. 12 is a diagram of an exemplary acoustic module in accordance with an embodiment of the present technology.

FIG. 13 is a diagram of an exemplary kick stand assembly in accordance with an embodiment of the present technology.

FIG. 14 is a block diagram of an exemplary energy capture module in accordance with an embodiment of the present technology.

FIG. 15 is a flowchart of an exemplary method of generating electric power in accordance with an embodiment of the present technology.

FIG. 16 is a block diagram of an exemplary computer system in accordance with an embodiment of the present technology.

The drawings referred to in this description should be understood as not being drawn to scale except if specifically noted.

### DETAILED DESCRIPTION

Reference will now be made in detail to embodiments of the present technology for self-powering on-board power generation, examples of which are illustrated in the accompanying drawings. While the technology for self-powering on-board power generation will be described in conjunction with various embodiments, it will be understood that they are not intended to limit the present technology for self-powering on-board power generation to these embodiments. On the contrary, the presented technology for self-powering on-board power generation is intended to cover alternatives, modifications and equivalents, which may be included within the spirit and scope of the various embodiments as defined by the appended claims.

Furthermore, in the following detailed description, numerous specific details are set forth in order to provide a thorough understanding of the present technology for self-powering on-board power generation. However, the present technology for self-powering on-board power generation may be practiced without these specific details. In other instances, well known methods, procedures, components, and circuits have not been described in detail so as not to unnecessarily obscure aspects of the presented embodiments.

### Overview

Cargo containers are often moved from one location to another location, and oftentimes one or more electronic devices may be coupled with or integrated into a transported cargo container. In order for such devices to continue to operate, these electronic devices are provided with an electric power source. In many instances, a battery or some other type of portable power source suitable for being attached to or installed within a container is utilized.

This method of providing power to electrical devices can oftentimes be costly and impractical. For instance, power sources such as batteries may have short life spans, and may be expensive to replace. Moreover, there are presently tens of millions of shipping containers being used throughout the world, and many of these containers are equipped with electronic devices that utilize batteries to operate. Therefore, there may be severe ecological dangers associated with not recycling such a large number of batteries. Indeed, many of these containers utilize multiple batteries, and many, if not most, of these batteries are simply discarded after being rendered inoperable.

Furthermore, being that tens of millions of shipping containers are currently in operation throughout the world, trying to keep track of current power supply levels for every electronic device in such a large number of containers would be a logistical nightmare. For this reason, simply utilizing rechargeable batteries to power these devices is not necessarily feasible, because trying to keep track of power levels of batteries utilized by tens of millions of containers can be quite impractical, and a process of swapping out charged batteries for drained batteries could be time consuming and tedious.

An embodiment of the present technology solves this problem by providing a means of self-powering on-board power generation, which can be used to provide a continuous supply of power to a mobile electronic device without needing to replace or manually recharge a power supply unit. An electronic device, and a rechargeable power source used to power the device, are attached to or installed within a shipping container. Kinetic energy associated with the motion of the shipping container is captured and utilized to generate electrical energy. This electrical energy may then be used to power the electronic device and/or recharge the rechargeable power source.

It is understood that various embodiments of the present technology teach utilizing the incredible weight of modern industrial cargo containers, which may weigh several tons each, in order to generate a relatively large amount of energy that may then be harnessed to provide a continuous supply of electric power to the containers' electronic equipment. Moreover, various implementations of the present technology may be configured to encompass more than a kinetic eccentric mass moment generation process. Rather, energy may be harvested from natural forces that a cargo container experiences when being transported based on the type of equipment or vessel that is utilized to transport the container. Indeed, one or more energy captor systems may be configured to capture energy based on specific types of motion of a cargo container such that the energy capturing process is extremely specialized and efficient.

### Power Generation and Energy Conversion

The term “power” has many different meanings, but may be broadly defined as the capacity to do a particular amount of work or transfer a particular amount of energy within a finite period of time. It follows that the terminology “electric power” may refer to the capacity to transfer an amount of electrical energy over a period of time. Kinetic energy may be broadly defined as the energy associated with the motion of an object. This is in contrast to potential energy, which connotes energy that is stored within a physical system, such as the electrochemical energy stored in a battery. The terminology mechanical energy is oftentimes used to describe the concept of kinetic energy; although this analogy may help in conceptualizing a use of the term kinetic, kinetic energy should not be mistaken with mechanical stress wherein a force is applied to an object but the object does not move. Rather, kinetic energy refers to the energy that an object possesses due to its motion, wherein the loss of such energy would cause the object to cease moving and enter into a static state.

In an embodiment, an electronic device is implemented, wherein the electronic device is powered by electrical energy. Moreover, the electronic device utilizes an electric power source capable of supplying a requisite amount of electrical energy to the electronic device such that the device continues to function over a period of time.

Various power sources may be utilized to provide electric power to the electronic device. In one embodiment, a voltaic cell is utilized to power the electronic device. For example, a voltaic cell is implemented wherein the voltaic cell is a battery that converts chemical energy into electrical energy. The battery is further configured to store chemical energy such that the battery is able to provide the electronic device with electrical energy at a subsequent point in time.

Moreover, in an embodiment, the electric power source utilized by the electronic device is rechargeable. Consider the example where the electric power source is a rechargeable battery wherein the chemical reactions of the rechargeable battery are reversible. In particular, a potential of the rechargeable battery to generate electric power at a future time is restored when an electric charge is applied to a chemical composition in the rechargeable battery.

In an alternative embodiment, the electric power source is a capacitor. The capacitor includes, for example, a pair of electrically conductive electrodes, or plates, that are separated by a dielectric, which acts as an insulator that prevents the flow of electrons between the plates. When an electrical current is applied to the capacitor, such as by a charging circuit, the current causes electrons to be deposited on one of the plates while electrons are simultaneously removed from the other plate. This results in a separation of electric charge within the capacitor, which develops an electric field between the plates, thus generating a voltage difference between the plates.

Moreover, the capacitor is also capable of being implemented as a back-up power source. Consider the example where a capacitor is connected to a rechargeable battery, and the rechargeable battery charges the capacitor while simultaneously delivering electric power to electronic device. When the energy stored in the rechargeable battery reaches a minimum threshold level, the rechargeable battery stops providing power to the capacitor and electronic device, and the capacitor provides power to the electronic device while the rechargeable battery is being recharged by another power source. Therefore, the capacitor stores electrical energy, and this energy is discharged to the electronic device when the capacitor is disconnected from a charging circuit.

Therefore, in an embodiment, a rechargeable power source, such as a rechargeable battery or capacitor, is used to receive electric power from a secondary power source and store the received power for future use. Various devices may be employed to provide such power to a rechargeable power source. For instance, thermoelectric devices are configured to convert thermal differentials into electric voltages, piezoelectric devices convert mechanical strain into electrical energy, and betavoltaic devices produce electricity from radioactive decay. However, pursuant to one embodiment, an electrical generator is utilized to convert kinetic energy into electrical energy. This electrical energy is then provided to an electronic device and/or a rechargeable power source.

Generally, electrical generators produce electricity by converting kinetic energy acquired from a body or object in motion into electrical energy. An electrical generator will usually include some sort of mechanical device, such as a rod or lever, upon which a body in motion can exert a mechanical force resulting from the body's kinetic energy. This mechanical force then transfers at least a portion of energy from the kinetic energy of the moving body to the electrical generator, which can convert the acquired energy into electrical energy.

In an embodiment, an electrical generator converts kinetic energy into electrical energy through a process of electromagnetic induction. Consider the example where the electric generator acquires kinetic energy from an object in motion, and uses the acquired energy to exert a mechanical force on an electrical conductor such that the conductor is moved through a magnetic field, and such that an electrical potential difference is generated between the ends of the electrical conductor. A voltage is therefore produced across an electrical conductor moving through a stationary magnetic field, and this voltage is used to provide or discharge electrical energy to a target device when the polarized ends of the electrical conductor are connected to the device through a closed circuit.

Alternatively, however, a voltage is generated across an electrical conductor located in a changing magnetic field. For example, a magnetized medium is moved relative to an electrical conductor, and this movement of the magnetized medium induces an electric field in the electrical conductor. This electric field induces an electric current that delivers power to a target device, such as an electronic device or a rechargeable power source, when the electrical conductor is connected to the target device in a closed circuit configuration.

Various exemplary implementations will now be discussed. Although various embodiments teach converting kinetic energy into electric power, and storing this power for future use by an electronic device, the spirit and scope of the present technology is not limited to these disclosed embodiments.

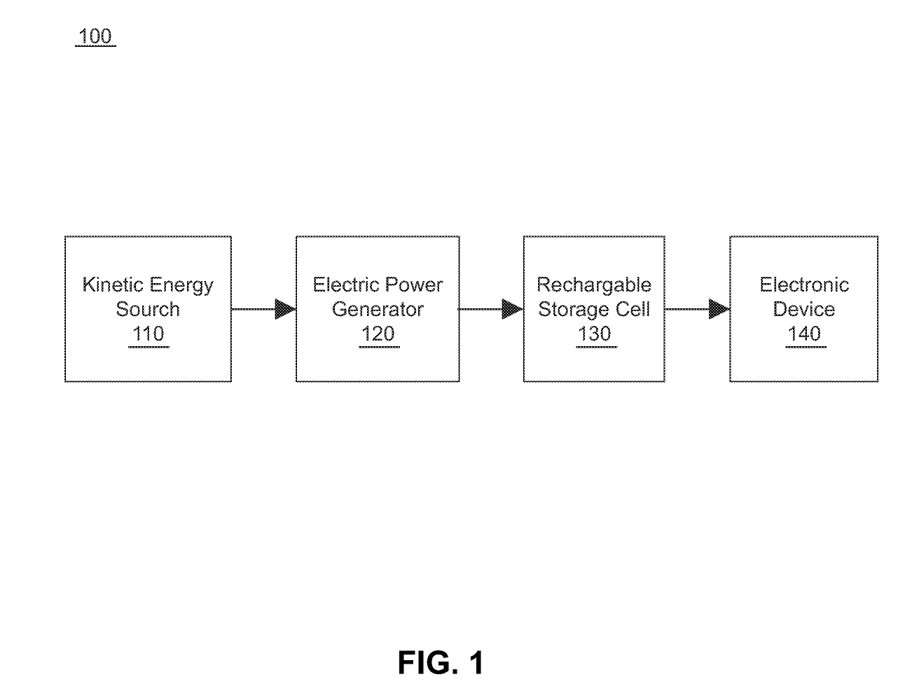

With reference now to FIG. 1, an exemplary energy conversion and storage system 100 in accordance with an embodiment is shown. Energy conversion and storage system 100 includes a kinetic energy source 110 configured to transfer an amount of kinetic energy to an electric power generator 120. Electric power generator 120 is configured to convert the kinetic energy into electrical energy, which is provided to a rechargeable storage cell 130. Rechargeable storage cell 130 utilizes this electrical energy to provide power to an electronic device 140 configured to perform an operation by utilizing an electric power source.

The kinetic energy that is transferred to electric power generator 120 by kinetic energy source 110 is energy associated with the movement of an object in motion. In an example, the kinetic energy is the result of a linear movement of the object. Alternatively, the kinetic energy results from a non-linear motion of the object, such as a rotation, sway, vibration or oscillation of the object. Pursuant to one embodiment, however, the kinetic energy is associated with both linear and non-linear motions of the object that occur simultaneously.

An embodiment provides that kinetic energy source 110 is itself an object in motion, and kinetic energy source 110 is configured to transfer a mechanical force to electric power generator 120, wherein this applied mechanical force causes the kinetic energy of kinetic energy source 110 to be transferred to electric power generator 120. In an alternative implementation, however, kinetic energy source 110 is configured to transmit kinetic energy from a separate object to electric power generator 120. Consider the example where kinetic energy source 110 includes a mechanical rod or lever. An object in motion comes into contact with the rod or lever and causes kinetic energy source 110 to transfer a generated amount of mechanical energy to electric power generator 120.

Once electric power generator 120 receives the kinetic energy from the kinetic energy source, electric power generator 120 converts the kinetic energy into electrical energy. In one embodiment, electric power generator 120 utilizes a process of electromagnetic induction to generate an electric current within an electrical conductor. For example, electric power generator 120 includes a magnetic device configured to generate a magnetic field, and electric power generator 120 moves the electrical conductor relative to the magnetic device, or the magnetic device relative to the electrical conductor, in order to generate an electrical potential difference between the ends of the electrical conductor.

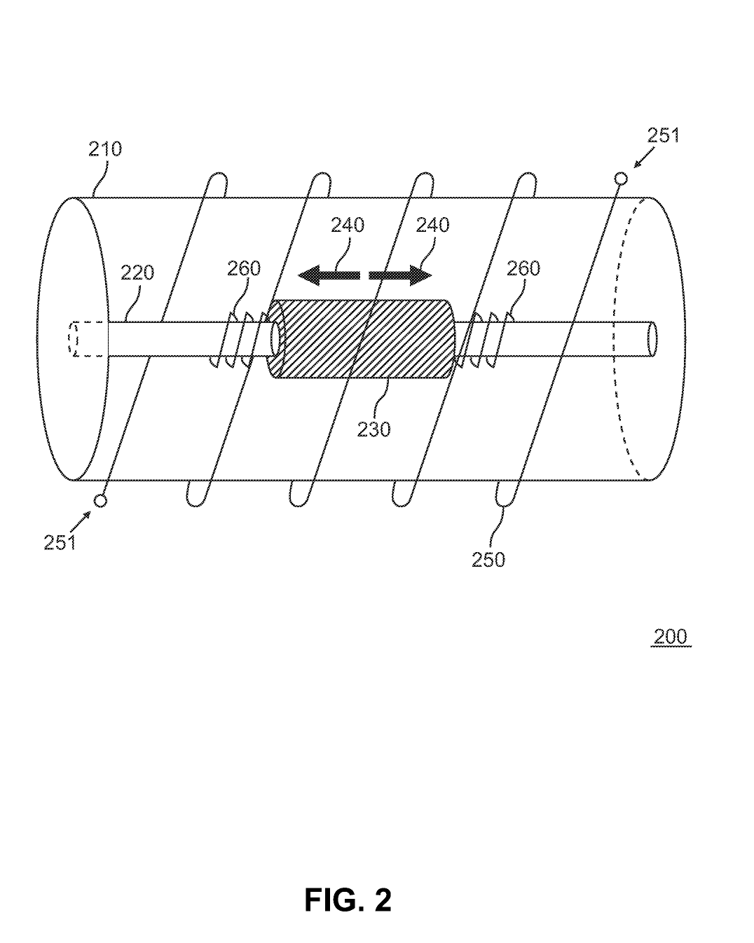

To further illustrate, and with reference now to FIG. 2, an exemplary energy converter 200 in accordance with an embodiment is shown. Energy converter 200 includes a stator 210 that houses a rail 220. A magnet 230 is moveably coupled with rail 220 such that magnet 230 is able to slide or move about rail 220 in displacement directions 240 along the major axis of rail 220. Moreover, a coil 250 is wound around stator 210 and rail 220 such that a movement of magnet 230 induces an electrical current across coil 250.

Coil 250 includes an electrically conductive material that is capable of conducting a magnetically induced electric current. Thus, in an embodiment, coil 250 includes a wound metal coil that is positioned relative to magnet 230 such that the creation or alteration of a magnetic field by magnet 230 induces a movement of electrons within coil 250. Coil 250 may include, for example, an electrically conductive metal selected from a group of metals consisting of gold, silver and copper metals.

With reference still to FIG. 2, in an embodiment, optional spring assemblies 260 are coupled with magnet 230. Optional spring assemblies apply mechanical resistance to magnet 230 when magnet 230 moves in displacement directions 240 such that magnet 230 travels a certain distance along rail 220 and is then pushed and or pulled in the opposite direction by optional spring assemblies 260. Thus, a back-and-forth motion is created such that the amount of current that is induced within coil 250 may be maximized.

Therefore, the movement of magnet 230 in displacement directions 240 causes an electric current to be induced within coil 250. This induced current causes a voltage potential to build between leads 251 of coil 250, and this voltage may be used to drive an electric current in an electrically conductive load when such load is electronically coupled with leads 251. In one example, the generated electric power is harnessed and delivered to an external device. In this manner, energy converter 200 is able to transform kinetic energy into electric power such that energy converter 200 functions as an electric power source for one or more devices.

Thus, with reference again to FIG. 1, electric power generator 120, pursuant to an embodiment, has a configuration substantially similar to that of energy converter 200. This electromechanical configuration enables electric power generator 120 to convert kinetic energy received from kinetic energy source 110 into electrical energy.

In an alternative embodiment, a pendulum is coupled with a shaft, and a movement of the pendulum rotates the shaft relative to a stator. Moreover, a magnet is coupled with the shaft such that the rotation of the shaft causes the magnet to move relative to an electrically conductive coil. The movement of the magnet relative to the coil induces an electrical current in the coil, and this electrical current may be harnessed as electrical energy. In this manner, the movement of an eccentric mass may be utilized to drive a current inducing member of electric power generator 120.

Energy converter 200 has been described herein so as to illustrate an exemplary configuration of electric power generator 120. However, this exemplary configuration is not meant to limit the spirit or scope of the present technology. Indeed, one embodiment provides that electric power generator 120 generates electric power utilizing a methodology other than electromagnetic induction. Consider the example where electric power generator 120 is a thermoelectric device that converts a thermal differential into an electric voltage. Alternatively, electric power generator 120 includes a piezoelectric device that converts mechanical strain into electrical energy, or an electroactive polymer (EAP) medium that converts mechanical vibrations into an electric potential.

With reference still to FIG. 1, once this energy conversion process has taken place, the electrical energy is transferred to rechargeable storage cell 130, which captures the energy for future use. It is understood that various types of energy storage units are capable of being implemented. In one embodiment, rechargeable storage cell 130 is a rechargeable battery configured to chemically store the energy acquired from a received electrical charge. This chemically stored energy is subsequently utilized to generate a voltage differential between two electrically conductive leads of the battery, and the generated voltage is applied across a resistive load that comes in contact with both of these leads.

In an embodiment, rechargeable storage cell 130 is a capacitor comprising a pair of electrically conductive electrodes separated by a dielectric medium. When rechargeable storage cell 130 receives the generated electrical energy in the form of an electrical current, electrons are deposited on one of the electrodes and removed from the other electrode such that the two electrodes no longer include an equal number of electrons. This polarization of the two electrodes causes an electric field to be generated between a pair of electrodes, and this electric field represents potential energy associated with a built-up concentration of electrons on one of the electrodes. Rechargeable storage cell 130 stores this energy until an electrically conductive medium contacts the electrodes so as to provide an electrically conductive path through which the electrons will flow from an area of a higher concentration of electrons to an area of a lower concentration.

With reference still to FIG. 1, energy conversion and storage system 100 further includes electronic device 140, which is configured to perform an operation by utilizing an electric power source. In particular, electronic device 140 is configured to receive electrical power from rechargeable storage cell 130. Therefore, electric power is generated by electric power generator 120 and transmitted to rechargeable storage cell 130, which stores energy associated with the generated electric power, and provides electric power to electronic device 140.

In an embodiment, kinetic energy source 110 continues to provide kinetic energy to electric power generator 120 over a period of time, and, as a result, electric power generator 120 continues to provide electric power to rechargeable storage cell 130. Rechargeable storage cell 130 stores the acquired energy such that rechargeable storage cell 130 is able to continue to provide electronic device 140 with electrical energy for at least as long as kinetic energy source 110 continues to provide electric power generator 120 with kinetic energy. However, in one embodiment, rechargeable storage cell 130 is configured to store electric power for a period of time subsequent to the point in time that kinetic energy source 110 stops providing kinetic energy to electric power generator 120.

In an alternative embodiment, rechargeable storage cell 130 includes a rechargeable battery that is coupled with a capacitor. Consider the example where rechargeable storage cell 130 is configured such that a rechargeable battery acts as a primary power source for electronic device 140. Once a level of stored electric charge in the battery reaches a certain minimum threshold, the battery is recharged by electric power generator 120. During this recharging stage, the capacitor, which has already been charged by electric power generator 120, discharges electrical energy so as to power electronic device 140 until the level of stored electric charge in the battery reaches a requisite operating threshold. In one example, this configuration is utilized to prevent information stored in volatile memory in electronic device 140 from being lost while the battery is recharging.

### Cargo Container Transportation

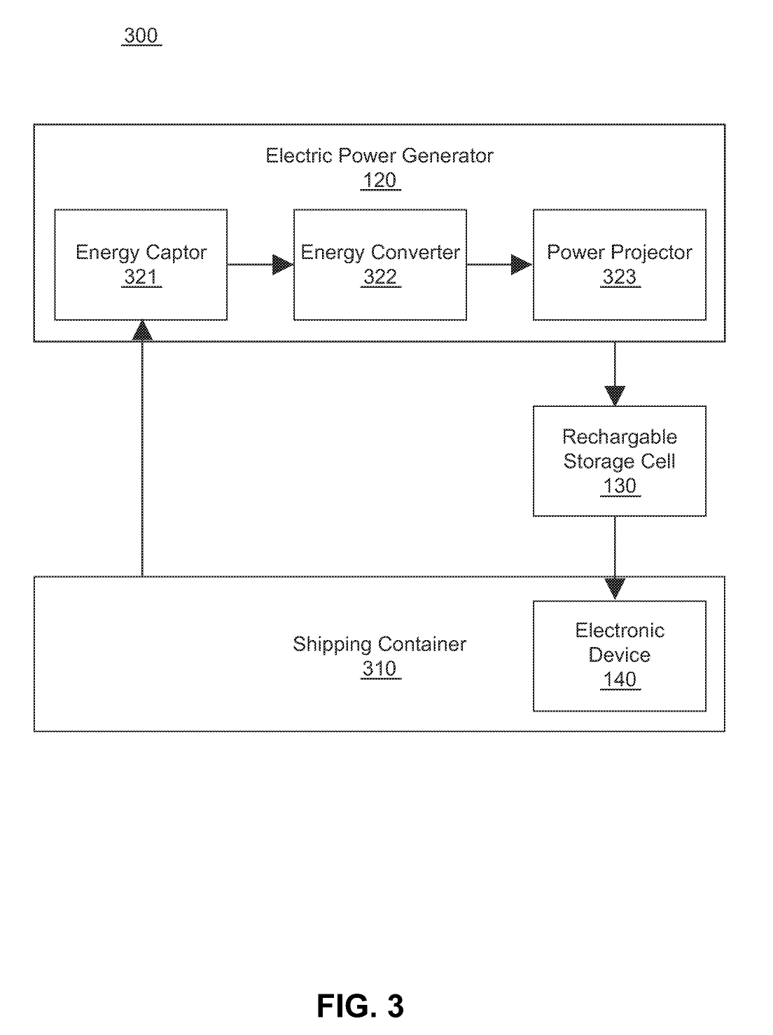

With reference now to FIG. 3, an exemplary self-powering on-board power generation system 300 in accordance with an embodiment is shown. Self-powering on-board power generation system 300 includes a shipping container 310 that is designed to transport cargo from a source location to a destination. Transportation of shipping container 310 generates kinetic energy that is transferred to electric power generator 120, which is configured to convert the kinetic energy into electrical energy.

In one embodiment, electric power generator 120 has a configuration substantially similar to that of energy converter 200, and this configuration enables electric power generator 120 to transform the kinetic energy received from kinetic energy source 110 into electrical energy using a process of electromagnetic induction. This electrical energy is then harnessed and delivered to a target device.

With reference still to FIG. 3, the electrical energy generated by electric power generator 120 is transferred to rechargeable storage cell 130, which stores the received energy for later use. In an example, the energy stored in rechargeable storage cell 130 is used to provide power to electronic device 140. In this manner, self-powering on-board power generation system 300 provides a means of converting movement of shipping container 310 into power for various devices, such as electronic device 140, which are mounted on or placed within shipping container 310.

Cargo containers, such as shipping container 310, are generally subject to external forces that result in container movement, such as a crane lifting the container, or motion of the container due to wave-generated ship motion. As a result of these varying movements, the containers are subjected to transient forces. These transient forces are of sufficient amplitude that the kinetic energy that may be harvested from the movement of such containers, when adequately processed and stored, is sufficient to provide a surplus of power, and this power surplus may be utilized as a power source for equipment located adjacent to or within these containers.

Furthermore, while in transit, such cargo containers may often sway or move around within the shipping vessel. For instance, many modern cargo containers may weigh several tons each, and an acceleration of such a large mass will result in such a container moving in a particular direction with a strong directional force. If the shipping vessel in which such a large cargo container is being moved does not continue to move in the same direction and with the same degree of force with which the container has been accelerated, the position of the container may shift relative to the vessel unless a canceling frictional force is applied to a surface of the container. However, frictional forces experienced by such heavy containers are oftentimes not strong enough to completely preclude any positional shifting of the containers while in transit.

Therefore, cargo containers having large masses experience strong mechanical forces during transit, and these forces allow the containers to move. Some of these forces are desirable, such as forces associated with the dislocation of a cargo container onto a shipping vessel using a cargo crane, but other forces are undesirable, such as those forces associated with the white noise and sliding that may be experienced by a container when it is moved. Since cargo containers can oftentimes weigh several tons, the mechanical forces required to move such containers are relatively strong, and the resulting kinetic energy associated with the movement of these containers is significant when compared to the movement of a lighter physical object. Thus, the kinetic energy that can be harvested from the movement of such containers, when adequately processed and stored, is sufficient to provide a continual power source for equipment located adjacent to or within these containers.

In an embodiment, kinetic energy associated with the motion of shipping container 310 is captured, and this captured kinetic energy is utilized to generate electric power. With reference still to FIG. 3, electric power generator 120 includes an energy captor 321 configured to capture the kinetic energy provided by shipping container 310. In one example, the captured kinetic energy results from forces that push, pull, vibrate or sway shipping container 310 while it is in transit. Energy captor 321 forwards the captured energy to an energy converter 322, which is configured to convert kinetic energy into electrical energy. After energy converter 322 has generated an amount of electrical energy, such energy is provided to a power projector 323, which transmits the electrical energy to rechargeable storage cell 130. Rechargeable storage cell 130 stores the received energy and uses this energy to provide electric power to electronic device 140.

In one embodiment, the amount of kinetic energy that is provided by shipping container 310 is proportional to the potential energy, which corresponds to the mass of shipping container 310 and the range of motion of this mass, as it is unloaded and loaded. Consider the example where energy captor 321 is externally mounted to shipping container 310 such that a weight of shipping container 310 drives a mechanical displacement of a component of energy captor 321, wherein kinetic energy associated with this mechanical displacement is delivered to energy converter 322. In this manner, a container that weighs six tons, for example, provides more available potential energy than a container weighing six pounds.

Therefore, with reference to the previous embodiment, increasing the weight of shipping container 310 allows a greater amount of energy to be provided to energy converter 322, which consequently creates a greater amount of electrical energy. In an example, shipping container 310 is able to support more electronic equipment, or utilize devices that require a greater amount of electric energy, when compared to a lighter container, due to the increased level of power generation of shipping container 310 that results from the increased weight of shipping container 310.

Various means for capturing kinetic energy and converting such energy into electric power may be implemented. Although various techniques for achieving these goals are discussed herein, these techniques are not meant to limit the spirit and scope of the present technology.

### Container Displacement

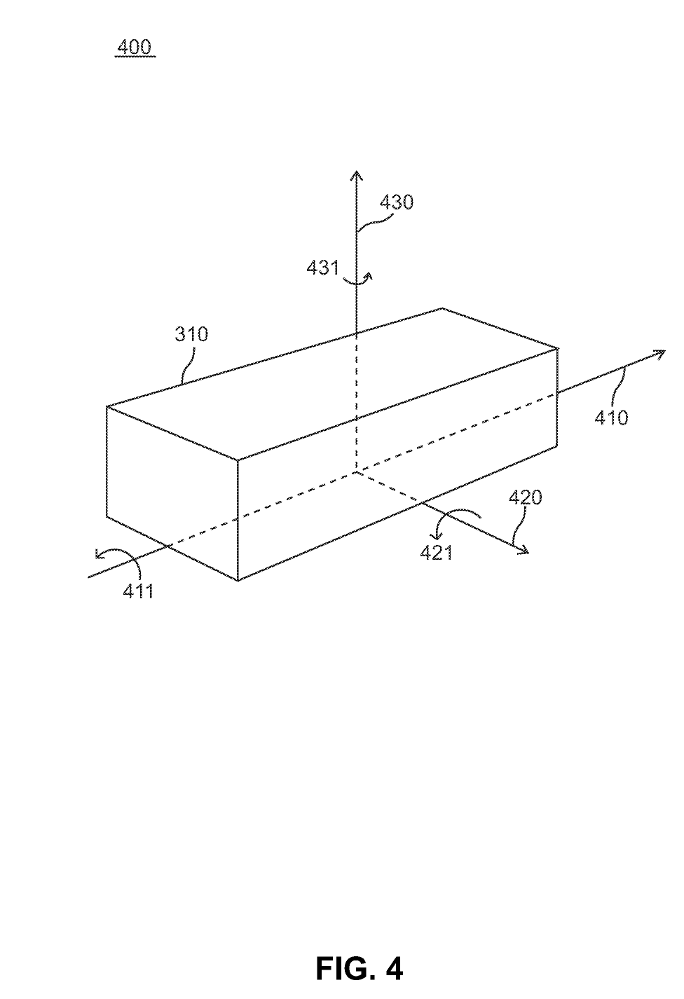

Prior to analyzing various exemplary techniques for capturing kinetic energy associated with a movement of a cargo container, such as shipping container 310, it is useful to understand how shipping container 310 may be displaced. With reference now to FIG. 4, an exemplary positional referencing schema 400 in accordance with an embodiment is shown. As shown in FIG. 4, shipping container 310 has a major axis 410 that is substantially parallel to a length of shipping container 310. A minor axis 420 is also shown, wherein minor axis 420 is substantially parallel to a width of shipping container 310, and wherein minor axis 420 is substantially perpendicular to both major axis 410 and a gravity vector 430. Furthermore, gravity vector 430, which runs parallel with a gravitational force acting upon shipping container 310, is substantially parallel to a height of shipping container 310.

With reference still to FIG. 4, the position of shipping container 310, pursuant to an exemplary embodiment, changes over time as a result of external forces acting upon shipping container 310. Consider the example where shipping container 310 is sitting on a dock and is about to be loaded onto a ship using a crane. The crane raises shipping container 310 in a direction that is substantially parallel to gravity vector 430. Next, the crane moves shipping container 310 in a direction that substantially parallels minor axis 420 until shipping container 310 is located above a loading platform on the ship. Furthermore, once shipping container 310 has been successfully loaded on the ship such that major axis 410 is, for example, substantially aligned with a forward trajectory of the ship, shipping container 310 moves in a direction that is substantially parallel to major axis 410.

In one embodiment, shipping container 310 rotates relative to major axis 410, minor axis 420 or gravity vector 430. In a first example, shipping container 310 rolls along major axis 410 in a first direction 411. In a second example, the pitch of shipping container 310 relative to major axis 410 changes when shipping container 310 turns about minor axis 420 in a second direction 421. Finally, in a third example, shipping container 310 yaws about gravity vector 430 in a third direction 431 such that a height of shipping container 310 remains substantially perpendicular to both major axis 410 and minor axis 420.

In an alternative embodiment, the position of shipping container 310 is displaced pursuant to a combination of two or more types of movements. Consider the example where shipping container 310 is raised by a crane in a direction substantially parallel to gravity vector 430, yet while shipping container 310 is suspended relative to a ground plane, shipping container 310 also turns pursuant to third direction 431. Furthermore, the pitch of shipping container 310 is simultaneously changed when an end of the shipping container drops relative to the ground plane in second direction 421.

To further illustrate, an embodiment provides that shipping container 310 rotates relative to major axis 410, minor axis 420 and/or gravity vector 430 as a result of a movement of a shipping vessel used to transport shipping container 310, such as a ship at sea. Consider the example where a ship is transporting shipping container 310 in an open ocean. Rather than traveling pursuant to a smooth, uninhibited trajectory, various external forces act upon the ship. For example, strong winds and/or waves in the ocean will cause the ship to rock relative to the ocean surface. Therefore, in so much as shipping container 310 is supported upon a surface of the transporting vessel, strong winds or ocean waves cause shipping container 310, for example, to roll in first direction 411 while simultaneously banking in second direction 421.

### Eccentric Mass Power Generation

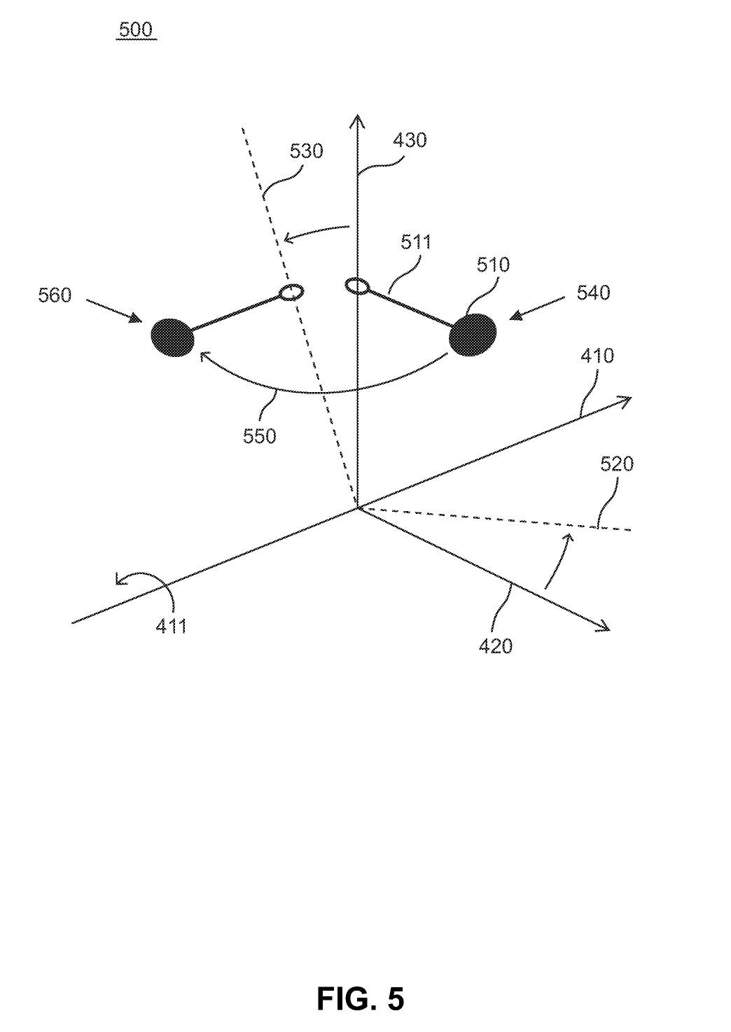

With reference now to FIG. 5, an exemplary eccentric mass configuration 500 in accordance with an embodiment of the present technology is shown. An eccentric mass 510 is shown, wherein eccentric mass 510 is coupled with shipping container 310. A movement of shipping container 310 causes eccentric mass 510 to also move since eccentric mass 510 is coupled with shipping container 310. In this manner, kinetic energy associated with a movement of shipping container 310 is transferred to eccentric mass 510.

With reference still to FIG. 5, eccentric mass 510 is affixed to a side of shipping container 310 (not shown) by a fixture 511, wherein minor axis 420 is substantially perpendicular to the aforementioned side of shipping container 310. Moreover, fixture 511 includes a rigid material that suspends eccentric mass 510 above a ground plane with reference to which gravity vector 430 is substantially perpendicular. However, fixture 511 is rotateably coupled with the aforementioned side of shipping container 310 such that eccentric mass 510 swings within a horizontal plane in response to encountering a horizontal force other than a vector force that is parallel to minor axis 420.

Moreover, when shipping container 310 rolls about major axis 410 in first direction 411, the side of shipping container 310 to which eccentric mass 510 is affixed is skewed such that a height of this side of shipping container 310 is substantially perpendicular to a first displacement axis 520 and substantially parallel to a second displacement axis 530. This change in displacement of shipping container 310, along with a force of gravity acting upon eccentric mass 510, causes eccentric mass 510 to rotate from a first reference position 540 to a second reference position 550 in a rotational direction (indicated by arrow 560). In this manner, kinetic energy associated with a movement of shipping container 310 is transferred to eccentric mass 510.

Therefore, an embodiment translates a relatively small displacement of shipping container 310 into a relatively significant motion of eccentric mass 510. This allows the kinetic energy captured by eccentric mass 510 to be maximized such that a greater amount of kinetic energy may be delivered to a power generator, such as electric power generator 120.

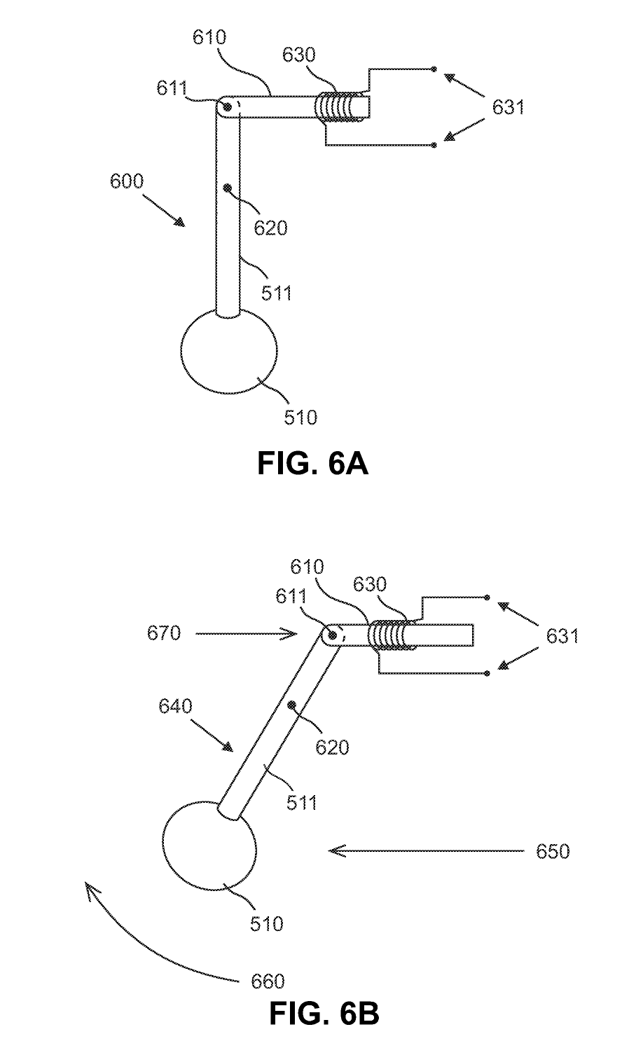

With reference now to FIG. 6A, a first exemplary electrical current induction configuration 600 in accordance with an embodiment is shown. Eccentric mass 510 is coupled with an end of fixture 511, and fixture 511 is rotatably coupled with an extendable member 610 at a joint 611. In addition, fixture 511 is moveably coupled with a side of shipping container 310 (not shown) at a pivot point 620 such that fixture 511, eccentric mass 510 and extendable member 610 rotate about pivot point 620 when a force is applied to eccentric mass 510, thereby causing extendable member 610 to move linearly relative to an electrical conductor 630.

With reference still to FIG. 6A, extendable member 610 is located adjacent to electrical conductor 630. In the illustrated embodiment, for example, a portion of electrical conductor 630 is wound in a coil configuration, and extendable member 610 is positioned within the coiled portion of electrical conductor 630. Moreover, extendable member 610 is magnetized such that a movement of extendable member 610 within the confines of electrical conductor 630 creates a voltage differential to build across primary leads 631 of electrical conductor 630.

With reference now to FIG. 6B, a second exemplary electrical current induction configuration 640 in accordance with an embodiment is shown. A movement of shipping container 310 (not shown) causes a force (indicated by arrow 1250) to be exerted on eccentric mass 510. In response to this force, eccentric mass 510 and fixture 511 rotate about pivot point 620 in a rotational direction (indicated by arrow 1260). This causes extendable member 610 to be moved relative to the coiled portion of electrical conductor 630 (in a direction indicated by arrow 670), since electrical conductor 630 is fixed relative to pivot point 620. As a result, a voltage is generated across primary leads 631, and this voltage is utilized to drive an electrical current to a resistive load when such a load is electrically coupled with primary leads 631 so as to create a closed circuit configuration.

Pursuant to one embodiment, primary leads 631 are connected to a rectifier arrangement configured to electrically rectify the generated electrical current. The rectifier arrangement may include, for example, one or more solid state diodes, vacuum tube diodes, or mercury arc valves configured to electrically conduct the electrical current in a first direction while resisting a conduction of the electrical current in a second direction. Moreover, in one example, the rectifier arrangement is used to implement a process of half-wave rectification, such as to minimize the number of components utilized. In an alternative embodiment, however, a process of full-wave rectification is used to more efficiently transfer the electric current and minimize power loss.

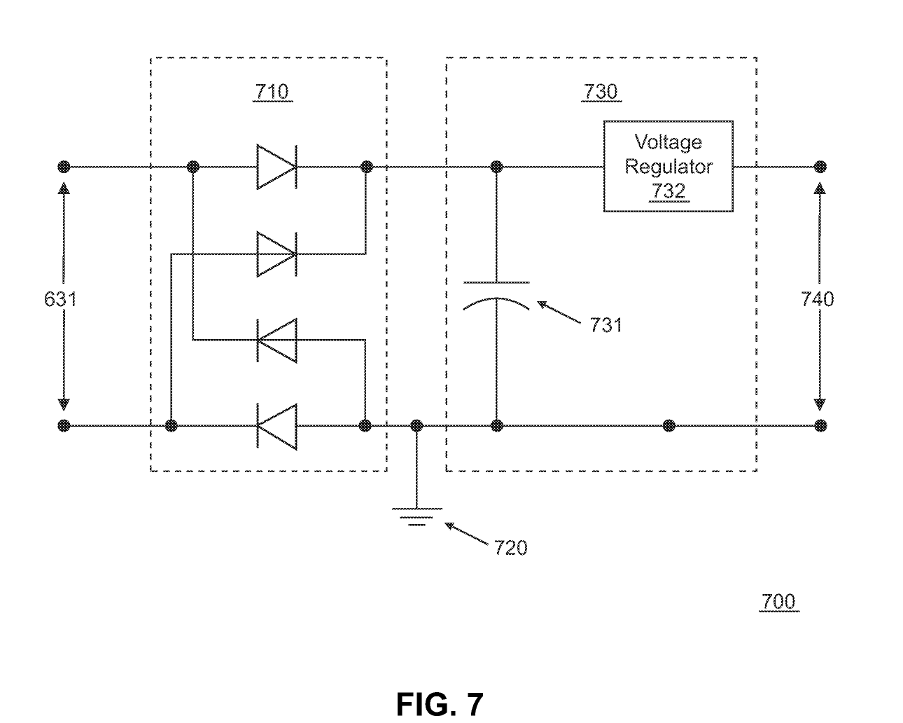

With reference now to FIG. 7, an exemplary electronic processing system 700 in accordance with an embodiment is shown. Current generated in electrical conductor 630 is routed to electronic processing system 700 through primary leads 631. This current travels through diodes in a diode assembly 710, which is configured to implement a process of full-wave rectification. Moreover, the anodes of at least two diodes from diode assembly 710 are electronically coupled with a ground reference 720 so as to provide a polarity reference during the rectification process.

With reference still to FIG. 7, the current travels through a voltage supply network 730, which includes a capacitor 731 that is electronically coupled with a voltage regulator 732. The current charges capacitor 731, which acts as a temporary storage unit for the generated electric power. The voltage drop across capacitor 731, with respect to ground reference 720, is inputted to voltage regulator 732, which is configured to provide a voltage across secondary leads 740. Moreover, the voltage provided by voltage regulator 732 has a constant magnitude, within a characteristic level of tolerance associated with voltage regulator 732. In this manner, the voltage provided across secondary leads 740 is kept relatively constant even when the voltage drop across capacitor 731 fluctuates.

Pursuant to one example, voltage regulator 732 is utilized to deliver a regulated voltage to an electric power source, such as rechargeable storage cell 130. This regulated voltage is used to charge the electric power source at a specific power threshold so as to prevent overcharging of the electric power source. Therefore, voltage regulator 732 is configured to deliver a specific amount of power depending on a power rating of the electric power source so as to prevent the power source from being damaged.

FIGS. 5, 6A and 6B have been presented herein so as to demonstrate various exemplary embodiments of kinetic energy capture. However, other methods of energy capture may also be implemented in accordance with the spirit and scope of the present technology. Consider the example where an eccentric mass 510 is coupled with a gear train such that a movement of eccentric mass 510 with respect to shipping container 310 causes eccentric mass 510 to drive the gear train, such as in a rotational motion. The gear train is coupled with electric power generator 120, such as by means of an axle, spindle or actuation assembly, such that the movement of the gear train relative to electric power generator 120 causes the gear train to apply a mechanical torque to electric power generator 120. Electric power generator 120 uses this mechanical torque to capture an amount of kinetic energy associated with the drive of the gear train, and electric power generator 120 uses this energy to generate an amount of electric power.

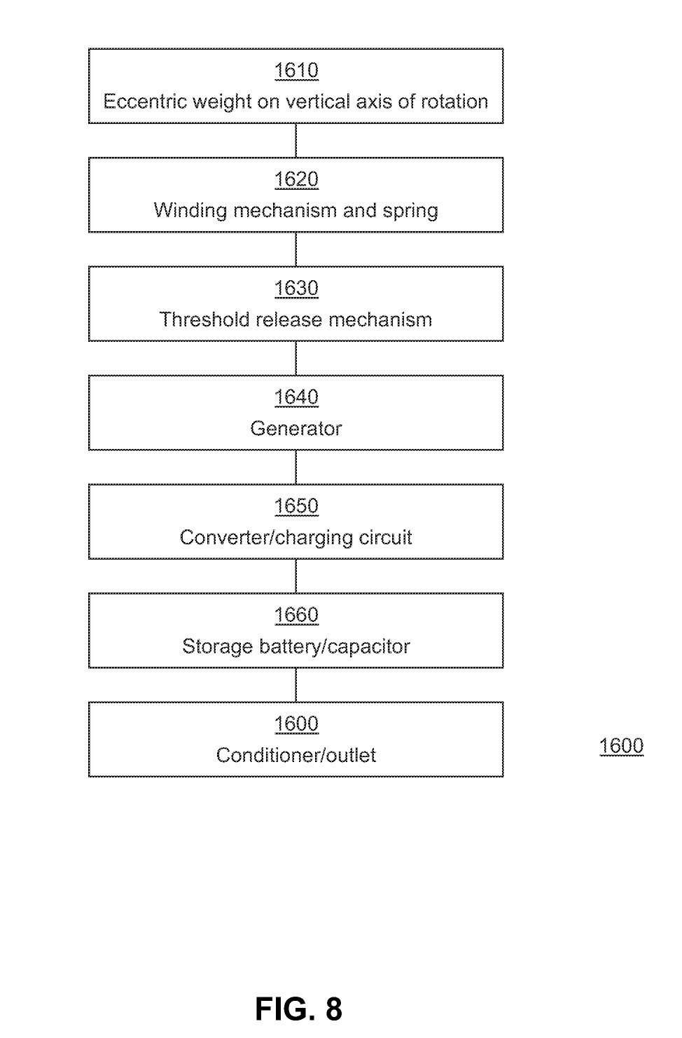

With reference now to FIG. 8, an exemplary power generating configuration 1600 in accordance with an embodiment is shown. An eccentric weight on a vertical axis of rotation 1610 is coupled with a winding mechanism and spring 1620 such that a movement of eccentric weight on a vertical axis of rotation 1610 causes a winding force to be applied to winding mechanism and spring 1620. Moreover, a threshold release mechanism 1630 is coupled with winding mechanism and spring 1620 such that kinetic energy associated with a movement of eccentric weight on a vertical axis of rotation 1610 is transferred to a generator 1640 when winding mechanism and spring 1620 has been wound to a particular threshold level.

Once generator 1640 has generated an amount of electric energy, generator 1640 transmits this electric energy to a converter/charging circuit 1650, which is used to convert the generated electric energy into a form that may be efficiently stored. The converted energy is then routed to a storage battery/capacitor 1660, which stores the energy for future use. When a device is ready to use the stored energy, the energy is provided to the device through a conditioner/outlet 1670, which is configured to route the energy to the device by means of a specific output configuration with which the device is compatable.

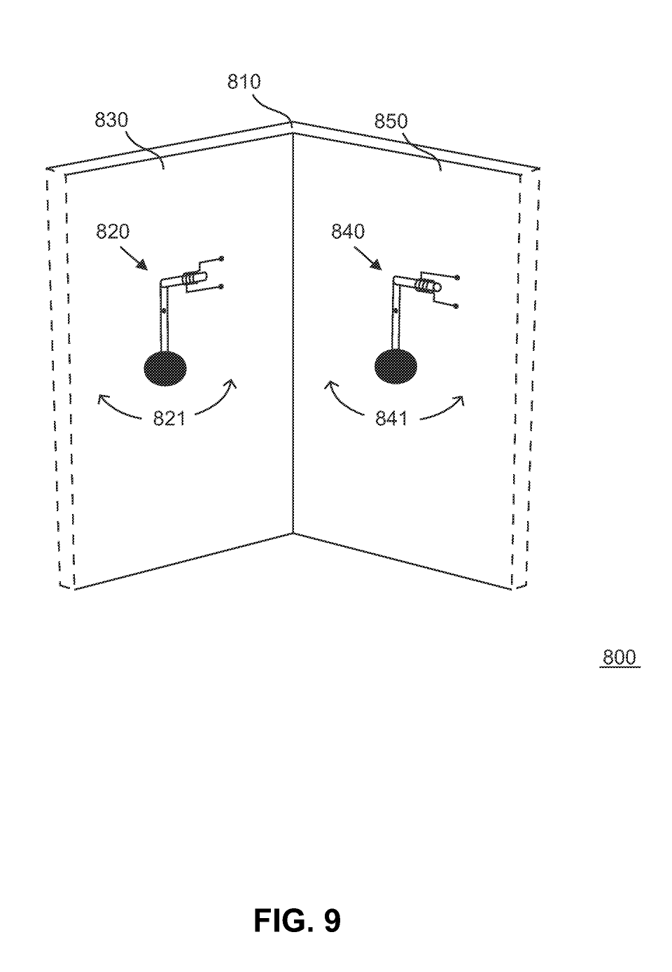

In an embodiment, multiple eccentric mass power generation systems are integrated in shipping container 310 so as to capture kinetic energy associated with different motions of shipping container 310. With reference now to FIG. 9, a multi-directional energy capture configuration 800 in accordance with an embodiment is shown. A corner portion 810 of shipping container 310 is shown, wherein a first eccentric mass power generation system 820 is attached to a first side 830 of shipping container 310. In addition, a second eccentric mass power generation system 840 is mounted to a second side 850 of shipping container 310, wherein second side 850 is located adjacent to first side 830.

With reference still to FIG. 9, first eccentric mass power generation system 820 swings with respect to first side 830 in rotational directions (indicated by arrows 821) in response to a first motion of shipping container 310. Consider the example where first eccentric mass power generation system 820 rotates in response to an increase in acceleration of shipping container 310 in a horizontal direction that is substantially perpendicular to second side 850. Thus, shipping container 310 moves pursuant to a first motion, which causes a vector force, such as a vector force that runs substantially perpendicular to second side 850, to cause first eccentric mass power generation system 820 to rotate within shipping container 310. In a second example, first eccentric mass power generation system 820 rotates with respect to first side 830 in response to a rolling of shipping container 310 about a rotational axis that is substantially perpendicular to first side 830. In this manner, kinetic energy associated with the movement of shipping container 310 pursuant to a first motion is captured by first eccentric mass power generation system 820.

Furthermore, second eccentric mass power generation system 840 is configured to swing with respect to second side 850 in rotational directions (indicated by arrows 841) in response to a second motion of shipping container 310 that is different than the first motion. Consider the example where second eccentric mass power generation system 840 rotates in response to an increase in acceleration of shipping container 310 in a horizontal direction that is substantially perpendicular to first side 830. Alternatively, shipping container 310 rolls about a rotational axis that is substantially perpendicular to second side 850, which causes second eccentric mass power generation system 840 to rotate with respect to second side 850.

Thus, multi-directional energy capture configuration 800 provides a means of capturing kinetic energy associated with different movements of shipping container 310 in various directions. However, multi-directional energy capture configuration 800 is not limited to the use of two eccentric mass power generation systems. In an embodiment, a third eccentric mass power generation system is mounted to a top side (not shown) of shipping container 310, wherein the top side is located adjacent to both first side 830 and second side 850. Moreover, pursuant to one example, shipping container 310 has six different sides, and at least one eccentric mass power generation system is mounted to each of these sides. This configuration increases the number of devices that are simultaneously employed to capture kinetic energy associated with different movements of shipping container 310 such that the captured kinetic energy is maximized.

Multi-directional energy capture configuration 800 has been described herein as an example of how a multi-directional energy capture system may be implemented pursuant to various embodiments. However, different multi-directional energy capture systems may also be implemented. For example, a multi-directional energy capture system may include multiple energy captors that are skewed so as to capture pitch and heave, either simultaneously or independently.

### Electroactive Polymer Actuation Power Generator

In an embodiment, electroactive polymers (EAPs) are utilized to capture kinetic energy from shipping container 310 and convert the kinetic energy into electrical energy. EAPs are polymers having a shape that changes in response to an applied voltage. Consider the example where a thin EAP layer is coupled between two electrodes. When a voltage is applied across the electrodes, the two electrodes attract each other, which causes the thickness of the EAP layer to contract while the area of the layer expands. In this manner, applied electrical energy is translated into mechanical energy. However, as described below, the EAP layer may also be implemented in a reverse mode to generate electrical energy in response to a sensed mechanical force.

Thus, pursuant to one embodiment, an EAP device is implemented in an electrical generator mode in order to convert mechanical energy, such as vibrational forces associate with a movement of shipping container 310, into electrical energy. For example, when shipping container 310 is being transported by a transporting vessel, the locomotion of the vessel may cause shipping container to experience mechanical vibrations. A wall of shipping container 310, with which the EAP device is mechanically coupled, then begins to vibrate, and the vibration of this EAP device allows the device to generate an electric potential in response to the external mechanical vibrations acting upon shipping container 310.

Various types of EAP devices may be used in accordance with the present technology. Indeed, the spirit and scope of the present technology is not limited to any single EAP-based configuration. However, an exemplary EAP device pursuant to an embodiment will now be described so as to provide an example of an EAP device that may be coupled with a side of shipping container 310 so as to perform the operations of energy captor 321 and energy converter 322.

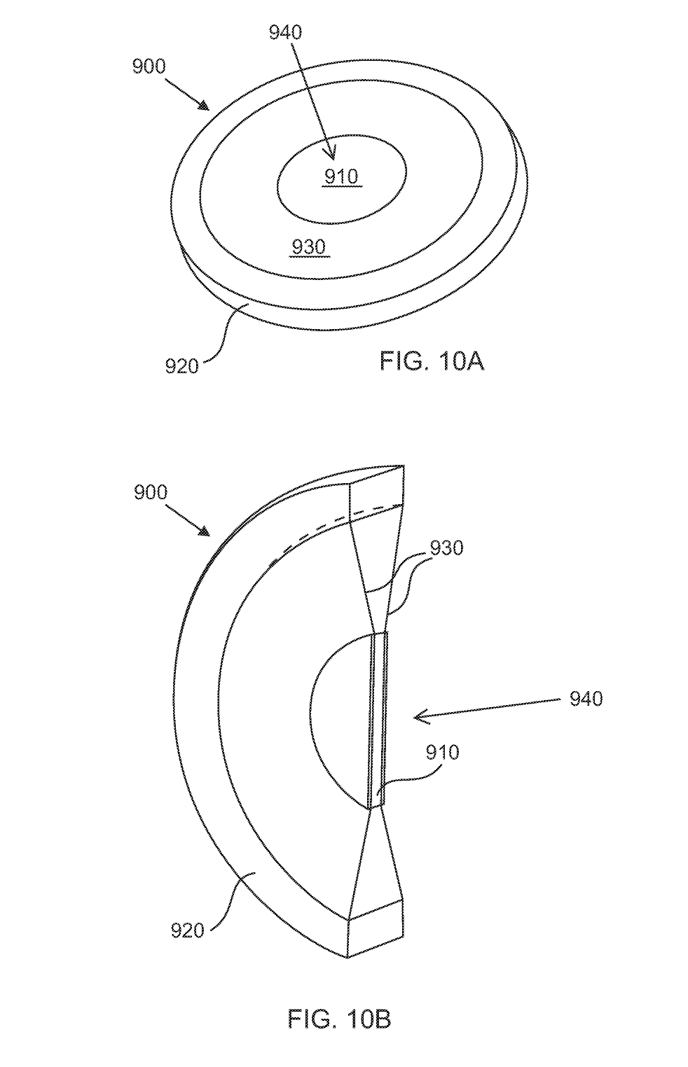

With reference now to FIGS. 10A and 10B, an EAP actuation power generator 900 in accordance with an embodiment is shown. EAP actuation power generator 900 includes a first electrode 910 separated from a second electrode 920 by a pair of polymer layers 930, which are coupled between first electrode 910 and second electrode 920. When a mechanical force 940 is applied to first electrode 910, first electrode 910 moves relative to second electrode 920. This causes the relative shapes of polymer layers 930 to change in response to the physical displacement of first electrode 910, and the EAPs that comprise polymer layers 930 cause a voltage differential to build between first electrode 910 and second electrode 920.

EAP actuation power generator 900 may be fabricated pursuant to various configurations. Indeed, the spirit and scope of the present technology is not limited to any single configuration. In one embodiment, polymer layers 930 are made of dielectric EAPs, wherein actuation of thin polymer layers 930 causes electrostatic forces to build between first electrode 910 and second electrode 920. In an alternative embodiment, polymer layers 930 are made of ionic EAPs, wherein actuation results in a displacement of ions inside polymer layers 930, which creates a net electrical charge that is then harnessed and stored for subsequent use.

### Pendulum Module

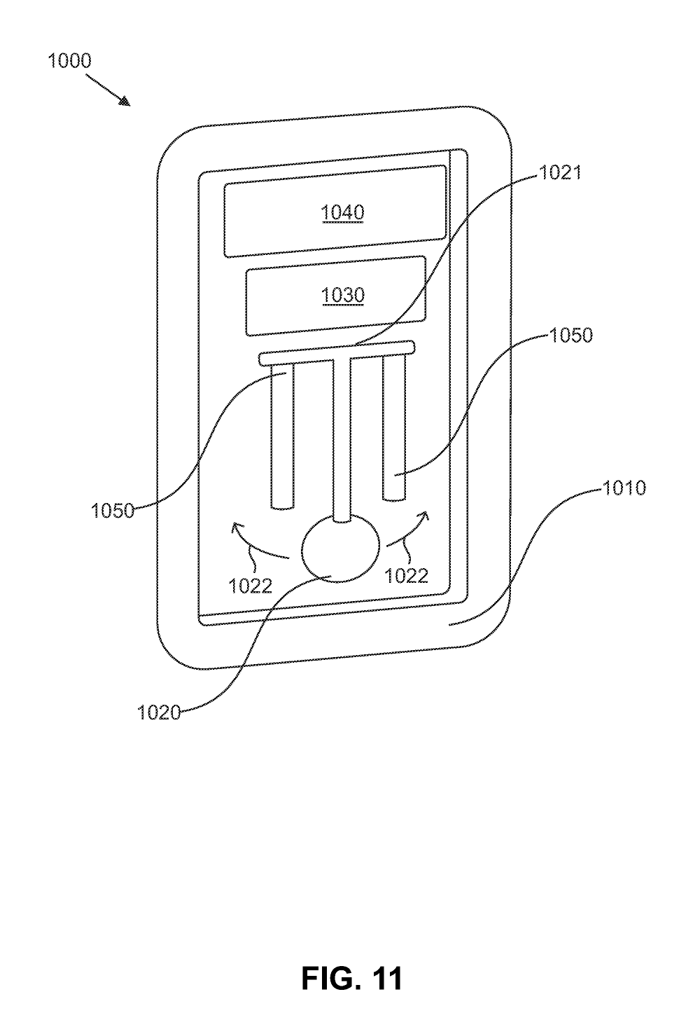

With reference now to FIG. 11, an exemplary pendulum module 1000 in accordance with an embodiment is shown. Pendulum module 1000 includes a housing unit 1010 with which a pendulum 1020 is moveably coupled. In particular, pendulum 1020 is moveably coupled with housing unit 1010 by means of a pivot assembly 1021 such that pendulum 1020 is free to rotate about pivot assembly 1021 in rotational directions (indicated by arrows 1022). Moreover, pendulum 1020 has a finite mass that is acted upon by forces generated by accelerations, such as lateral velocity changes or gravitational acceleration. When housing unit 1010 is initially at rest, pendulum 1020 is similarly at rest in a first position, but when housing unit 1010 experiences a physical displacement, pendulum 1020 swings to a second position relative to housing unit 1010.

Thus, when an acceleration-induced force, such as gravity, acts upon the finite mass of pendulum 1020, pendulum 1020 begins to swing relative to housing unit 1010. However, acceleration due to gravity is an example of an acceleration in a particular direction. Indeed, acceleration-induced forces may be generated by accelerations in other directions.

In an embodiment, pendulum module 1000 is implemented such that pendulum 1020 utilizes gravitational forces or lateral accelerations to create kinetic energy associated with a movement of an object with which housing unit 1010 is coupled. For example, housing unit 1010 is attached to a side of shipping container 310, and a displacement of shipping container 310 causes pendulum 1020 to swing relative to housing unit 1010. The kinetic energy associated with the movement of pendulum 1020 is subsequently translated into electrical energy. In one embodiment, and with reference again to FIG. 4, an axis of rotation of pendulum 1020 is oriented parallel with respect to gravity vector 430. In this manner, as the transporting vessel pitches or rolls, the axis of rotation is shifted from local vertical and pendulum 1020 is able to rotate about pivot assembly 1021.

With reference still to FIG. 11, pendulum module 1000 further includes a printed circuit assembly 1030 and a power storage unit 1040. In one example, printed circuit assembly 1030 captures electrical energy that is generated in response to a movement of pendulum 1020, and transmits this energy to power storage unit 1040. Power storage unit 1040 then stores this electrical energy for later use.

In an embodiment, rechargeable storage cell 130 is used to power electronic device 140, which is coupled with or contained within shipping container 310. Moreover, electrical energy is temporarily stored in power storage unit 1040 and is then transmitted to rechargeable storage cell 130. Rechargeable storage cell 130 then uses this energy to provide power to electronic device 140.

In an alternative embodiment, printed circuit assembly 1030 is configured to monitor a present power level of the energy stored in rechargeable storage cell 130, and allows electrical energy stored in power storage unit 1040 to be transmitted to rechargeable storage cell 130 when rechargeable storage cell 130 has a present capacity to store an additional amount of electric power.

Various methods may be implemented for translating a movement of pendulum 1020 about pivot assembly 1021 into electric energy. Although exemplary implementations are discussed herein, the spirit and scope of the present technology is not limited to any single implementation.

In an embodiment, electric power generator 120 is coupled with pendulum module 1000. A movement of pendulum 1020 about pivot assembly 1021 winds a spring, or turns a rigid shaft, so as to translate kinetic energy from pendulum module 1000 to electric power generator 120.

Moreover, in one example, pendulum 1020 is configured to accelerate in a manner that creates a relatively substantial voltage output. For example, a magnet is coupled with pendulum 1020, or, alternatively, pendulum 1020 is magnetized. Next, the angular movement of shipping container 310 causes a displacement of pendulum 1020 such that, at a certain inclination, pendulum 1020 magnetically latches to a predetermined stationary object. Pendulum 1020 then remains latched and stationary, relative to the predetermined stationary object, until the angle of inclination due to the movement of shipping container 310 is great enough to overcome the magnetic latching force. Once the magnetic latching force is overcome, pendulum 1020 is then free to rotate about pivot assembly 1021 with an initial acceleration due to the rate of change for the angle of inclination.

In an alternative embodiment, a magnetic field is generated in response to a change in a position of pendulum 1020 relative to housing unit 1010, and electric power is generated in response to this magnetic field. For example, pendulum 1020 is coupled with a magnet, or is itself magnetized. Pendulum 1020 rotates past a magnetically permeable material wrapped in a coil of electrically conductive material. The magnetic field induces an electric current in the electrically conductive material, and this current is harnessed such that electric energy associated with the current is used by electronic device 140, or stored by rechargeable storage cell 130 for future use.

In an embodiment, a combination of mechanical and EAP power generation devices is utilized to translate a motion of shipping container 310 into electrical energy. Consider the example where pendulum module 1000 includes at least one EAP power generator such that the kinetic energy associated with a movement of pendulum 1020 is translated to the EAP power generator, which generates a voltage differential in response to the kinetic energy. This voltage is then used to store electric power in power storage unit 1040.

With reference still to FIG. 11, pendulum module 1000 includes a set of linear tube EAP power generators 1050 coupled with pendulum 1020. Linear tube EAP power generators 1050 are shaped such that they are suspended with respect to a base of pendulum 1020 in a direction substantially equal to a vector direction of a gravitational force. Furthermore, linear tube EAP power generators 1050 are characterized as having a finite rigidity such that linear tube EAP power generators 1050 slightly bend in response to an applied rotational force, or in response to a gravitational force that acts upon the masses of linear tube EAP power generators 1050 in response to a shift in the displacement of a length of linear tube EAP power generators 1050 with respect to a vector direction of such force. In this manner, a displacement of pendulum 1020 causes linear tube EAP power generators 1050 to swing relative to a direction of gravity, which causes EAPs in linear tube EAP power generators 1050 to be displaced relative to one another, thus generating a voltage differential.

Alternatively, linear tube EAP power generators 1050 are integrated with pendulum module 1000 such that the motion of pendulum 1020 relative to housing unit 1010 is converted into tension in one EAP member and compression in the other. For example, linear tube EAP power generators 1050 are each coupled with pendulum 1020 and housing unit 1010. When pendulum 1020 swings relative to housing unit 1010, one EAP member is stretched while the other is compressed. The tension and compression forces acting upon linear tube EAP power generators 1050 causes the shape and area of linear tube EAP power generators 1050 to change, which results in linear tube EAP power generators 1050 generating an amount of electric power.

### Acoustic Membrane

When cargo containers are being transported, they often experience mechanical forces in the form of vibrations, or white noise. For instance, a cargo container may be loaded onto a train, and the movement of the train may generate vibrations that are physically transferred to the body of the cargo container, which in turn generates acoustic pressure transients. Certain materials, such as various types of metal alloys, may oscillate at a specific frequency in response to a mechanical vibration, which in turn causes a sound to be generated. Such sounds may be audible, but oftentimes resonate in a frequency range that is outside the audible spectrum of the inner ear of a human being. However various types of acoustic devices may be configured to respond to such vibrations, whether audible or not.

An embodiment implements an acoustic device that is tuned to respond to a range of frequencies pursuant to which a cargo container might resonate. Mechanical power associated with the kinetic energy of such vibrations is captured when such frequencies are generated, and this kinetic energy is converted into electric power. However, since sound waves may be attenuated over a distance through which the waves are propagated, in one embodiment, the acoustic device is mounted directly to a cargo container such that a mechanical vibration is more easily transferred to the device while minimizing an attenuation of the strength of a sensed vibration.

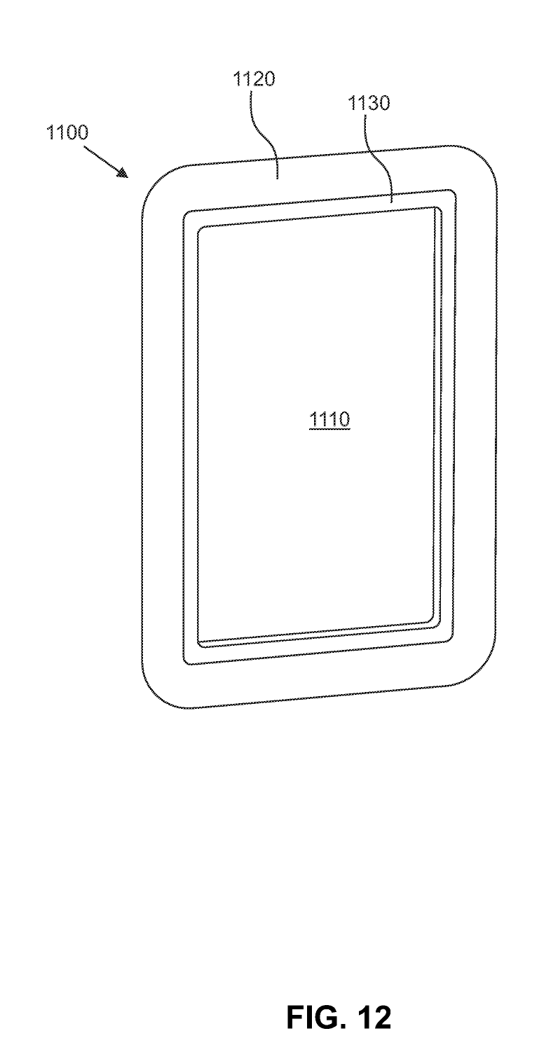

With reference now to FIG. 12, an exemplary acoustic module 1100 in accordance with an embodiment is shown. Acoustic module 1100 includes an acoustic membrane 1110 coupled with a support element 1120. Acoustic membrane 1110 includes a flexible material that is capable of vibrating at a frequency of a sensed mechanical vibration. Support element 1120 is comprised of a rigid material that provides a physical support structure for acoustic membrane 1110 such that the shape of acoustic membrane 1110 is expanded so as to be in a position to sense vibrations. As shown in the illustrated embodiment, support element 1120 completely surrounds acoustic membrane 1110. However, an implementation of an acoustic device in accordance with various embodiments is not limited to this design or arrangement.

With reference still to FIG. 12, acoustic module 1100 further includes a stiffening element 1130 configured to pull acoustic membrane 1110 taut such that acoustic membrane 1110 is adjusted to vibrate or resonate within a specific frequency range. In the illustrated embodiment, stiffening element 1130 is coupled with both acoustic membrane 1110 and support element 1120. An outer edge of acoustic membrane 1110 is located between support element 1120 and stiffening element 1130. Thus, stiffening element 1130 is configured to couple with support element 1120, and acoustic membrane 1110 is stretched such that the surface area of acoustic membrane 1110 is better able to sense mechanical vibrations and vibrate at a corresponding frequency.

In one embodiment, acoustic module 1100 is configured to couple with a side of shipping container 310 so as to collect white noise associated with mechanical vibrations experienced by shipping container 310. In particular, when shipping container 310 experiences mechanical vibrations, acoustic membrane 1110 will vibrate at a frequency that corresponds to a frequency of the environmental noises or vibrations. For example, vibrations that result from an operation of a shipping vessel used to transport shipping container 310 are also experienced by shipping container 310 when shipping container 310 is loaded on, or otherwise coupled with, the shipping vessel. After the kinetic energy of the sensed vibrations has been captured by acoustic module 1100, this energy is harnessed and converted into electrical energy, such as by energy converter 322 in electric power generator 120.

Pursuant to one implementation, acoustic module 1100 is located in a specific location adjacent to shipping container 310 based on a weight distribution associated with shipping container 310. For example, when a first portion of shipping container 310 is heavier than a second portion, acoustic module 1100 is located in a position relative to the heavier portion of shipping container 310 so as to maximize the kinetic energy captured during a movement of shipping container 310.

With reference again to FIG. 3, in an embodiment, acoustic module 100 is configured to perform operations of both energy captor 321 and energy converter 322. Consider the example where acoustic membrane 1110 is an EAP membrane that is coupled to a pair of electrodes. The EAP membrane is configured to vibrate in response to a sensed mechanical vibration, and then generate a voltage differential between the electrodes in response to the sensed vibration. In this manner, the size of electric power generator 120 used to provide power to rechargeable storage cell 130 is minimized since the size of acoustic membrane 1110 is configured to be relatively small in comparison to other energy capturing and conversion devices. When electric power generator 120 is located within shipping container 310, this implementation of acoustic membrane 1110 increases the cargo capacity of shipping container 310 since electric power generator 120 will occupy less space within shipping container 310.

In an alternative embodiment, acoustic membrane 1110 is used to induce a process of electromagnetic induction. Consider the example where acoustic membrane 1110 is coupled with an armature magnet of an electromagnetic power generator. When acoustic membrane 1110 moves with respect to support element 1120, the armature magnet is moved relative to an electrically conductive coil such that an electric current is induced across the coil. This current may then be harnessed such that an amount of electric power can be stored by rechargeable storage cell 130.

In one embodiment, a side of shipping container 310 has a number of physical hatches or concave protrusions. Rather than coupling acoustic module 1100 with this side of shipping container 310 such that acoustic module 1100 protrudes inward toward the cargo space of shipping container 310, acoustic module 1100 is attached to a wall of the container such that acoustic module 1100 is located within, or substantially within, one of these hatches or protrusions. In this manner, the cargo capacity of shipping container 310 is further increased. Therefore, the use of acoustic module 1100 to convert kinetic energy into electric power allows a cargo container to be self-powered, while the amount of cargo that such a self-powered container can carry is simultaneously maximized.

### Kick Stand Assembly

Due to the incredible weight of modern cargo containers, the movement of these containers requires a relatively large amount of kinetic energy. It follows that the ability to harness this significant degree of energy would be a useful tool in generating a significant amount of electric power. An embodiment of the present technology takes advantage of the substantial mass of a modern cargo container by utilizing one or more retractable members configured to extend from and retract toward such a container. When a force associated with the weight of the container is exerted on the retractable members, these members will retract toward the container. However, when such a force is removed, these members are then free to extend away from the container. Thus, the application of various forces to these retractable members will cause them to move relative to the cargo container, and the kinetic energy associated with the movement of these members may then be harnessed and converted into electric power.

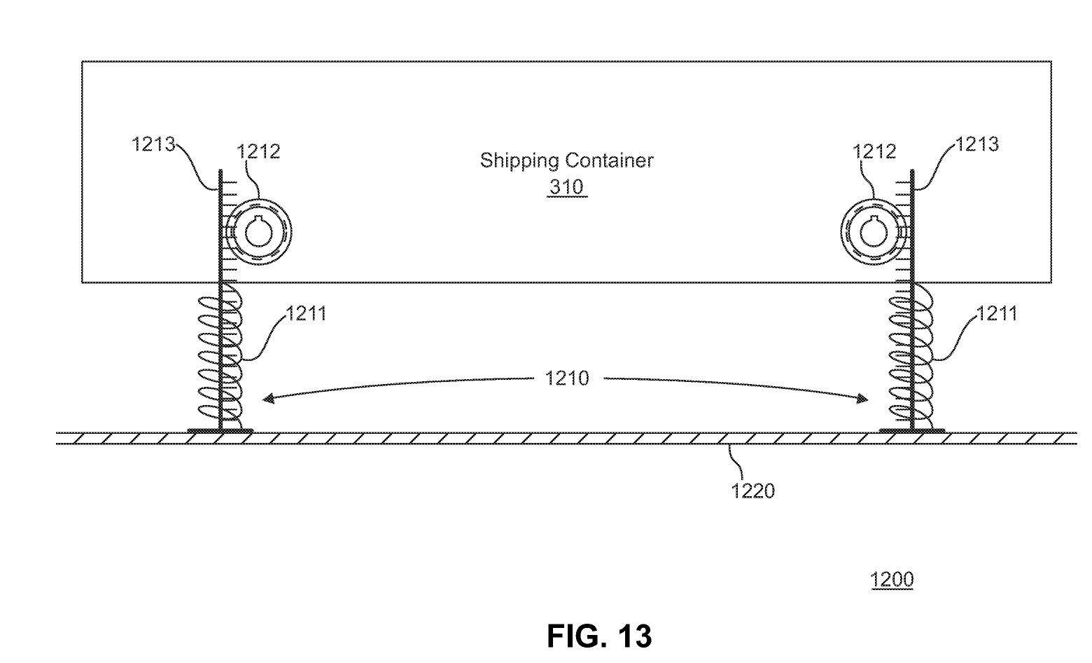

With reference now to FIG. 13, an exemplary kick stand assembly 1200 in accordance with an embodiment is shown. Kick stand assembly 1200 includes retractable legs 1210 that are moveably coupled with shipping container 310 such that the weight of shipping container 310 is applied to retractable legs 1210 under the force of gravity. Retractable legs 1210 extend outward from a bottom portion of shipping container 310, and are configured to physically contact a ground plane 1220 located below a position of shipping container 310. When the weight of shipping container 310 is applied to retractable legs 1210, a portion of retractable legs 1210 retracts into shipping container 310. However, when shipping container 310 is raised in a direction opposite the direction of gravity, such as when a crane lifts shipping container 310, a portion of retractable legs 1210 will extend from or move out of shipping container 310.

Therefore, a vertical movement of shipping container 310 causes retractable legs 1210 to move relative to shipping container 310. In the embodiment illustrated in FIG. 13, the motion of retractable legs 1210 is linear. However, in an alternative embodiment, retractable legs 1210 are configured to rotate about a base of shipping container 310. Moreover, the weight of shipping container 310 under a force of gravity is used to harness a significant amount of kinetic energy by means of inducing a movement of retractable legs 1210 when shipping container 310 is lowered to a ground plane. In particular, the kinetic energy associated with the movement of retractable legs 1210, which is caused by a vertical movement of shipping container 310, is harnessed and converted into electric power, such as by energy converter 322.

Various power generation configurations may be implemented to convert the motion of retractable legs 1210 into electric power. In an example, the motion of retractable legs 1210 relative to shipping container 310 is utilized to wind a spring that drives a motor generator. Pursuant to a second example, a magnetized medium is moved relative to an electrically conductive medium so as to induce a current across the electrically conductive medium. However, other power generation configurations may also be implemented.

With reference still to FIG. 13, shock absorbing elements 1211 are operatively coupled with retractable legs 1210 such that shock absorbing elements 1211 are compressed under the weight of shipping container 310, and such that a tension of shock absorbing elements 1211 is utilized to control the rate at which retractable legs 1210 extend and retract. In one embodiment, shock absorbing elements 1211 are springs or coils that are adjustable to achieve a desired tension between an end of retractable legs 1210 and a side of shipping container 310 under the force of gravity. In an alternative embodiment, shock absorbing elements 1211 are hydraulic shocks configured to withstand a relatively large amount of pressure. Thus, various shock absorbing devices may be employed that are capable of functioning under the weight of a cargo container weighing several tons.

Since kick stand assembly 1200 acquires kinetic energy associated with a range of motion of retractable legs 1210, a greater functional range of motion of the retractable legs equates to a greater amount of kinetic energy that may be harnessed. In an embodiment, the range of motion of retractable legs 1210 is increased to allow a greater amount of mechanical energy to be transferred to a generator, such as electric power generator 120. In this manner, electric power generator 120 is able to produce a greater amount of electric power.

In one embodiment, shock absorbing elements 1211 are used to maximize this range of motion. For example, retractable legs 1210 retract or collapse under the full weight of shipping container 310 when shipping container 310 is placed on or adjacent to ground plane 1220. However, when shipping container 310 is raised relative to the ground plane 1220, shock absorbing elements 1211 apply a push force to retractable legs 1210 that causes retractable legs 1210 to spring or extend outside of shipping container 310. In this manner, kick stand assembly 1200 is configured so as to avoid an instance of retractable legs 1210 becoming stuck inside shipping container 310 when shipping container 310 is raised, since retractable legs 1210 will be pushed out of shipping container 310 by shock absorbing elements 1211.

In an embodiment, shock absorbing elements 1211 are configured to be tuned so as to be more or less sensitive to mechanical forces. Consider the example where shock absorbing elements 1211 are tuned so as to cause retractable legs 1210 to spring out of shipping container 310 at a relatively quick rate of speed. Kinetic energy associated with a vertical rising of shipping container 310 is quickly captured before shipping container 310 subsequently descends. As a second example, shock absorbing elements 1211 are tuned so as to compress at a slower rate of speed such that shipping container 310 is slowly lowered toward ground plane 1220 when the weight of shipping container 310 is exerted on shock absorbing elements 1211. Thus, an embodiment provides a safety feature wherein shipping container 310 is slowly lowered so as to preclude a hard jarring of cargo within shipping container 310, or so as to aid in ensuring that there are no people or objects under shipping container 310 before shipping container 310 is lowered onto ground plane 1220.

Moreover, in one embodiment, kick stand assembly 1200 transfers kinetic energy to electric power generator 120 by utilizing a rack and pinion assembly. With reference still to FIG. 13, a movement of retractable legs 1210 relative to shipping container 310 causes concentric gears 1212 located inside shipping container 310 to turn. In order to achieve this result, in one example, retractable legs 1210 include linear transducers 1213, and straight-toothed gears are coupled with linear transducers 1213 such that a movement of retractable legs 1210 causes linear transducers 1213 to drive concentric gears 1212. Moreover, the turning of concentric gears 1212 causes a shaft (not shown) coupled with concentric gears 1212 to turn, wherein the turning of the shaft delivers mechanical energy to electric power generator 120. Electric power generator 120 then converts the received mechanical energy into electric power, which is provided to rechargeable storage cell 130.

A rack and pinion assembly, as described herein, is an example of a type of motion translation device. For example, a rack and pinion assembly may be implemented so as to convert linear motion into rotational motion. However, other types of motion translation devices may also be implemented. Indeed, a motion translation device may be used to capture pure rotational motion. Consider the example where an extendable member is forced to pivot relative to shipping container 310 due to a platform, such as a treadmill lift platform, being moved closer to shipping container 310. The pivoting of this extendable member enables a pure rotational motion to be captured, and this rotational motion may be used to drive electric power generator 120.

In one embodiment, the amount of kinetic energy that is provided by shipping container 310 is proportional to the available potential energy, which corresponds to the mass of shipping container 310 and the range of motion of this mass (for example, when shipping container 310 is being loaded or unloaded). The amount of kinetic energy that may be harnessed is related to the length of the shafts available on linear transducers 1213. Consider the example where energy is captured when shipping container 310 is lifted off, or put down upon, ground plane 1220. A weight of shipping container 310 drives a mechanical displacement of linear transducers 1213, wherein kinetic energy associated with this mechanical displacement is delivered to energy converter 322. Thus, an embodiment provides that the functional length of linear transducers 1213 is maximized such that a greater amount of kinetic energy may be captured in response to retractable legs 1210 having an increased range of motion.

Moreover, pursuant to an embodiment, the physical implementation of kick stand assembly 1200 is customizable with respect to the weight of shipping container 310. In one example, the size or positioning of the components of kick stand assembly 1200 is configured to be a function of the weight of shipping container 310 so as to maximize the amount of kinetic energy that may be captured during a movement of shipping container 310, which could weigh, for instance, several tons when fully loaded. Moreover, in an embodiment, retractable legs 1210 are located in a specific location adjacent to shipping container 310 based on a weight distribution associated with shipping container 310.

Therefore, an embodiment provides that kinetic energy is captured during a vertical motion of shipping container 310. For example, a suspension-based power generating configuration may be implemented wherein energy is captured during the compression or expansion of vertical shock absorbers. However, the spirit and scope of the present technology is not limited to the capture of kinetic energy in response to a vertical motion of shipping container 310.

Indeed, pursuant to an embodiment, an energy absorption unit is moveable in a direction that is not completely vertical with respect to ground plane 1220, such as in a substantially horizontal direction. Consider the example where an energy absorption unit is moveably coupled with a side of shipping container 310 such that the energy absorption unit is compressed when another container is positioned substantially adjacent to the aforementioned side. Therefore, various embodiments described herein may be implemented such that an energy absorption unit is coupled with a portion of shipping container 310 such that energy absorption unit is configured to absorb kinetic energy associated with a non-vertical movement of shipping container 310.

### Piezoelectric Devices

In another embodiment of the present technology, a piezoelectric device is used to convert kinetic energy associated with a movement of shipping container 310 into electric energy. The piezoelectric device includes a piezoelectric material that generates an electric potential in response to mechanical stress experienced by the material. The piezoelectric device further includes a set of electrodes coupled with the piezoelectric material. When an electric potential is generated by the piezoelectric material, a voltage is induced across the electrodes, and this voltage is used to drive electric power to either rechargeable storage cell 130 or directly to electronic device 140, which is located within or adjacent to shipping container 310.

In one embodiment, the piezoelectric device is mounted to a surface of shipping container 310. As a result of this orientation, a vibration of this surface, such as a vibration caused by a movement of shipping container 310, is mechanically translated to the piezoelectric material of the piezoelectric device due to the physical proximity of the piezoelectric material and the vibrating surface. The piezoelectric device then converts the sensed mechanical energy into electric power, which is harnessed for a subsequent use of electronic device 140.

In another embodiment, the size, shape or mass of the piezoelectric device is selected based on a weight of shipping container 310. In this manner, the piezoelectric device is implemented such that the kinetic energy harnessing process is customized with respect to the weight of shipping container 310.

The foregoing notwithstanding, in an embodiment, a nanogenerator is used to convert mechanical energy, such as the energy associated with mechanical vibrations experienced by shipping container 310, into an amount of electric energy. Consider the example where an array of nanowires is grown on an electrically conductive substrate. The nanowires include a piezoelectric material such that compressing or bending the nanowires causes an electrical charge to accumulate therein. The accumulated piezoelectric charge of the respective nanowires is then collected by the conductive substrate and used to deliver electrical energy to a target device.

The components of the nanogenerator may be manufactured or grown pursuant to various dimensions and arrangements. Indeed, the spirit and scope of the present technology is not limited to any one configuration. For example, in an embodiment, the nanowires of the nanogenerator may each have a diameter of approximately 30 to 100 nanometers and a length of between one and three micrometers. However, other dimensions for such components may also be implemented.

Additionally, in one embodiment, a thin layer of an adhesive substance is added to the surface of the conductive substrate with which the nanowires are coupled. This substance increases the strength of the adhesion between the nanowires and the substrate such that the nanogenerator is able to withstand an increased amount of mechanical stress without failing. In this manner, the overall efficiency of the nanogenerator may be increased.

Moreover, in an embodiment, the substrate is configured to bias the current generated from the accumulated piezoelectric charge in a particular direction. For example, the substrate may be coated with a biasing medium, such as a thin layer of platinum. The atomic properties of platinum cause the coated substrate to function as a diode, wherein electrical current is able to easily flow in a first direction while such flow is resisted in an alternative direction. Moreover, the electrical conductivity of platinum causes the overall conductivity of the substrate to be increased such that the amount of generated charge that is lost due to internal system resistance may be minimized, thereby increasing overall system efficiency and performance.

Finally, pursuant to one embodiment, multiple nanogenerators function in tandem such that the electrical energy generated by the respective nanogenerators is aggregated. To illustrate, in an example, a plurality of nanogenerators are arranged in series such that the aggregated output voltage of the nanogenerators is increased. Alternatively, multiple nanogenerators may be electronically coupled in parallel so as to increase the output current of these respective nanogenerators.

Thus, various embodiments teach the use of one or more nanogenerators to generate various degrees of electrical energy, such as through the harnessing of an induced piezoelectric charge. After the electrical energy has been generated, collected, biased, and/or aggregated, the energy may be sufficient to power, for example, a micro-electrical mechanical system (MEMS) based device, or a number of nanodevices, located within or adjacent to shipping container 310.

### Multi-Directional Energy Capture

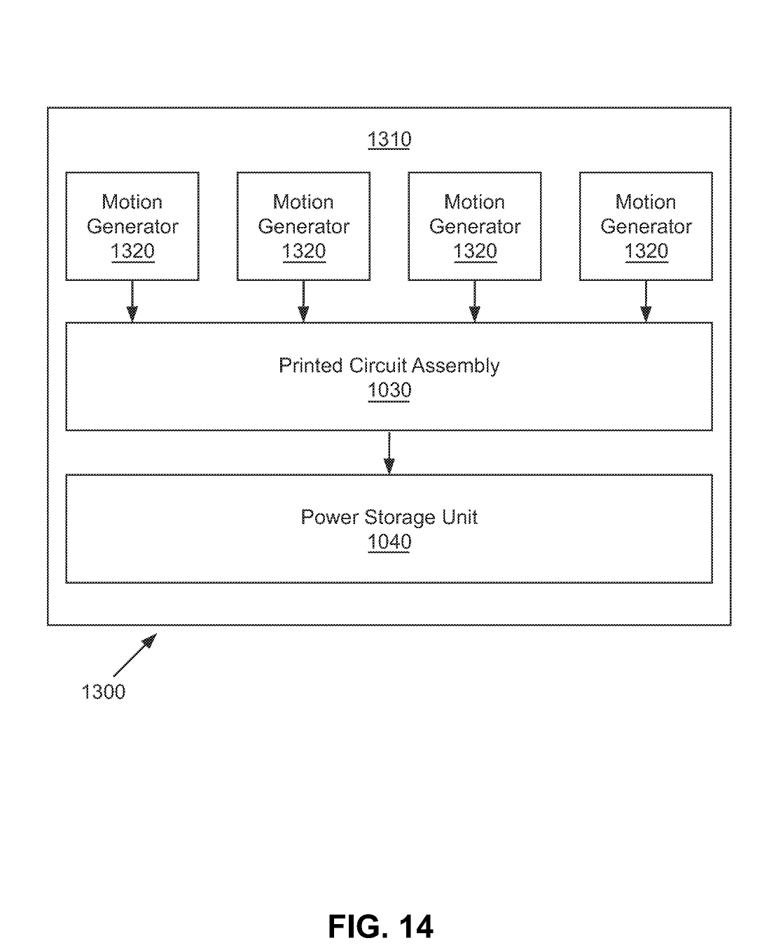

With reference now to FIG. 14, an exemplary energy capture module 1300 in accordance with an embodiment is shown. Energy capture module 1300 includes a housing unit 1310 that is configured to couple with a transported cargo container, such as shipping container 310. Energy capture module 1300 further includes motion generators 1320 that are configured to maximize the effect of a motion of a shipping vessel in which shipping container 310 is being transported. Motion generators 1320 are configured to move in response to a movement of the shipping vessel, and these movements are utilized to turn, oscillate or otherwise move one or more eccentric masses, such as eccentric mass 510, which are coupled with or embodied within motion generators 1320.

In an embodiment, motion generators 1320 are configured to respond to different types of motion experienced by the shipping container 310. In one example, energy capture module 1300 includes multiple wave generators that are oriented so as to maximize the effect of a vessel's natural motion while transporting shipping container 310. Various possibilities exist for implementing and configuring such a grouping of wave generators.

Consider the example where a motion generator utilized by energy capture module 1300 includes eccentric mass 510 and fixture 511 shown in FIG. 5, and this motion generator is configured to operate as a roll generator wherein kinetic energy is captured in response to a rolling of shipping container 310 about major axis 410. In particular, eccentric mass 510 is configured to rotate from first reference position 540 to second reference position 550 in a rotational direction (indicated by arrow 560) relative to a side of shipping container 310 with which energy capture module 1300 is coupled. This occurs, for instance, when shipping container 310 rolls about major axis 410 in first direction 411. In this manner, kinetic energy associated with a rolling motion of shipping container 310 is captured by a motion generator in energy capture module 1300.

In one embodiment, different types of motion generation devices are implemented such that motion generators 1320 are configured to respond to different types of motion experienced by shipping container 310. Consider the example where energy capture module 1300 includes multiple wave generators, wherein each wave generator is configured to respond to different types of motion. A physical displacement of shipping container 310 causes shipping container 310 to move in a vertical direction, a horizontal direction and a rotational direction, and the kinetic energy associated with each of these different movements is captured by a different motion specific wave generator.

To further illustrate, an example provides that one or more of motion generators 1320 are heave generators configured to respond to a linear displacement of shipping container 310, such as in a direction that is substantially parallel to major axis 410. In a second example, one or more pitch generators are implemented, wherein the pitch generators are configured to respond to, for instance, a change in slope of shipping container 310 when shipping container 310 banks about minor axis 420 in second direction 421. Indeed, one embodiment utilizes one or more yaw generators that capture kinetic energy when shipping container 310 turns or revolves about gravity vector 430.

The foregoing notwithstanding, an embodiment provides that energy capture module 1300 is configured to capture energy associated with certain types of movements while ignoring other movements. For example, a large container ship is utilized to transport shipping container 310, but the container ship does not experience significant yaw motion due to its large size. However, the container ship rolls and pitches in various directions in response to external forces, such as forces caused by waves and wind. Therefore, the kinetic energy associated with the roll and pitch motions of shipping container 310 are significant when compared to the nominal amount of kinetic energy associated with the small degree of yawing experienced by the cargo ship. Energy capture module 1300 is implemented to capture kinetic energy associated with such roll and pitch motions, while the nominal degree of yawing is ignored. In this manner, energy capture module 1300 is specialized so as to concentrate its efforts on one or more motions of interest.

To further illustrate, in an embodiment, energy capture module 1300 is integrated with one or more pendulum-based motion capture units. Consider the example where an eccentric mass pendulum module is implemented such that the axis of rotation of the pendulum is vertically oriented such that the axis of rotation is substantially parallel to gravity vector 430, and such that the pendulum rotates about this axis in a horizontal plane. In this manner, kinetic energy associated with roll and pitch motions experienced by shipping container 310 is captured as shipping container 310 moves and is affected by, for example, external forces caused by waves and wind.

Therefore, in an embodiment, motion generators 1320 are configurable to respond to specific types of movements (e.g., roll, pitch, yaw, heave, etc.) associated with the natural movement of a transport vessel, such as a ship at sea. In this manner, kinetic energy associated with the natural motion of the ocean is able to be efficiently harnessed and stored in order to provide a continuous supply of electric power to electronic device 140 in shipping container 310. Moreover, in one embodiment, energy capture module 1300 is implemented with various movement-specific motion generators that are configured to respond to specific types of movements such that motion generators 1320 perform very specialized functions that allow for a greater degree of accuracy and an increased degree of kinetic energy recognition and capture.

Once the kinetic energy is captured by motion generators 1320, this energy is converted into electrical energy, which is then stored for future use. An embodiment employs a process of electromagnetic induction to carry out this energy conversion process. In particular, kinetic energy associated with the movement of an eccentric mass is used to drive a motion of a magnetized object relative to an electrically conductive material to generate an electrical current.

In an alternative embodiment, energy capture module 1300 utilizes a rotational motion of an eccentric mass pendulum to wind a spring, thus storing kinetic energy as potential energy in the spring. With reference again to FIG. 11, consider the example where pendulum 1020 is coupled with a bi-directional spring winder such that a rotation of pendulum 1020 about pivot assembly 1021 in rotational directions (indicated by arrows 1022) winds a spring. The kinetic energy transferred to the spring is then transferred to a generator in the form of a mechanical force, which is used to drive the generator. For example, the spring is coupled with a rotor in the generator, such as rail 220 in energy converter 200, and a movement or expansion of the spring transfers an amount of mechanical force to the rotor, causing it to turn relative to a stationary portion of the generator, such as stator 210.

In one embodiment, the spring is configured to compress in response to a movement of pendulum 1020 relative to housing unit 1010 such that the winding of the spring causes a torque to be applied to the spring, wherein the applied torque is a function of the spring compression. Moreover, the spring remains in this compressed state until the applied torque reaches a certain threshold, at which time the spring will begin to unwind and expand. In this manner, the transfer of kinetic energy utilizing an eccentric mass spring assembly may be customized with respect to the magnitude of a generated torque. Once the threshold torque is realized, the spring unwinds and drives a generator.

Moreover, in an embodiment, the kinetic energy harnessing process is customized with respect to the weight of motion generators 1320, or a component thereof. With reference again to FIG. 5, an example provides that one or more of motion generators 1320 includes an eccentric mass pendulum module having eccentric mass 510, wherein a movement of eccentric mass 510 relative to shipping container 310 drives rail 220 in energy converter 200. A weight of eccentric mass 510 is increased so as to increase the force with which eccentric mass 510 moves relative to shipping container 310. This increased force causes rail 220 to move at a greater rate of speed relative to stator 210, which enables energy converter 200 to generate an increased amount of electric power.

With reference still to FIG. 14, housing unit 1310 further includes printed circuit assembly 1030 and power storage unit 1040. Printed circuit assembly 1030 is configured to capture the electrical energy that is generated in response to a motion of motion generators 1320, and transmit this energy to power storage unit 1040, which stores the energy for later use. With reference again to FIG. 3, consider the example where the electrical energy is temporarily stored in power storage unit 1040, and then transmitted to rechargeable storage cell 130 and used to power electronic device 140, which is coupled with or contained within shipping container 310. Moreover, in one embodiment, printed circuit assembly 1030 is configured to monitor a present power level of the energy stored in rechargeable storage cell 130, and allows electrical energy stored in power storage unit 1040 to be transmitted to rechargeable storage cell 130 when rechargeable storage cell 130 has a present capacity to store an additional amount of electric power.

In one embodiment, printed circuit assembly 1030 includes a bypass circuit configured to enable the captured electrical energy to avoid or bypass rechargeable storage cell 130 when an electric charge stored in rechargeable storage cell 130 reaches a threshold level. In this manner, damage to rechargeable storage cell 130, such as damage due to overcharging, may be prevented by adjusting the threshold level to fall within a safety tolerance spectrum associated with a safe charging of rechargeable storage cell 130.

For example, a comparator circuit is implemented wherein the charge stored in rechargeable storage cell 130 is compared with a reference voltage. If this reference voltage is greater than the charge of rechargeable storage cell 130, the captured electrical energy is routed to rechargeable storage cell 130 by means of a switch assembly in the comparator circuit, wherein the switch assembly includes one or more solid state transistors. Alternatively, if the reference voltage is lower than the charge stored in rechargeable storage cell 130, the captured electrical energy is routed to a different destination, or the comparator circuit open circuits so as to preserve this electrical energy until the charge of rechargeable storage cell 130 dissipates below the reference voltage.

Although various systems have been described herein for harnessing kinetic energy associated with an object in motion, such as shipping container 310, and/or converting such energy into electric power, various devices from the aforementioned embodiments may be combined in different arrangements so as to provide different or more comprehensive systems for providing a means of self-powering on-board power generation for a body or object in motion. Indeed, multiple energy acquisition and/or translation systems may be used together in a single container so as to more efficiently capture energy associated with various motions in different directions.

In one embodiment, a side of shipping container 310 contains a groove or ridge, and one or more of the devices described herein, such as energy captor 321, are configured to mount within such groove or ridge. Consider the example where a wall of shipping container 310 is corrugated such that a number of grooves are located on an inside portion of such wall. Energy captor 321 is positioned within one of these internal grooves such that energy captor 321 does not substantially protrude from the wall. A transportation of shipping container 310 causes shipping container 310 to experience various external forces, and these forces cause the corrugated wall to move or vibrate. Energy captor 321 then captures kinetic energy associated with this movement, and this kinetic energy may then be converted into electric power. However, in so much as energy captor 321 does not substantially protrude from the wall of shipping container 310, the cargo capacity of shipping container 310 may be increased.

### Method of Operation

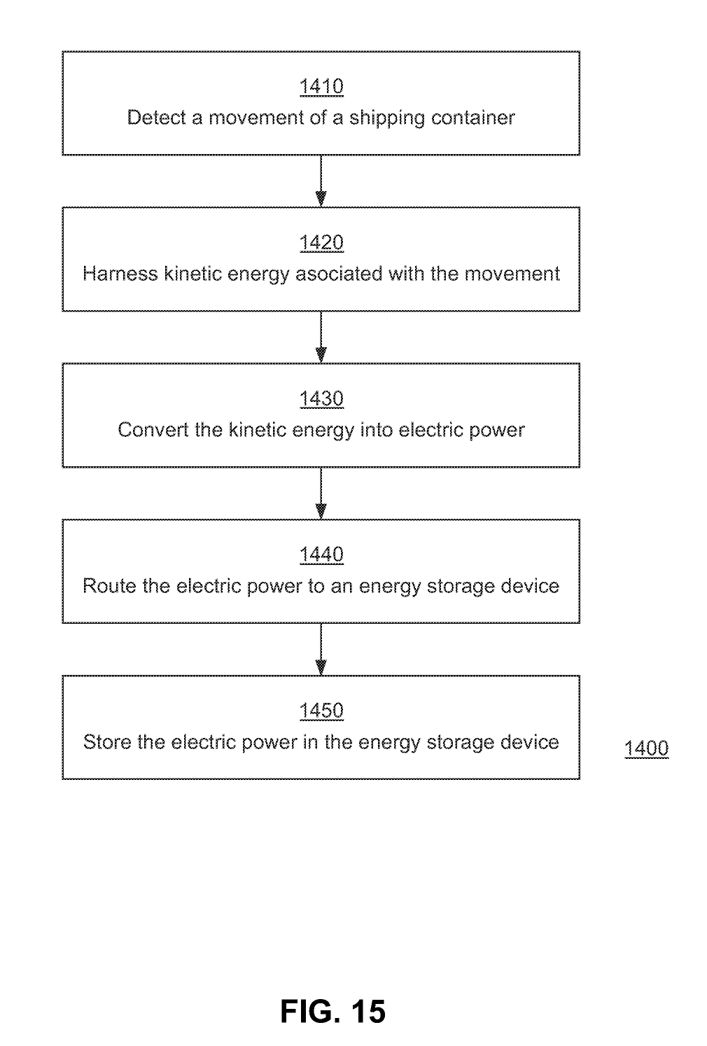

With reference now to FIG. 15, an exemplary method 1400 of generating electric power in accordance with an embodiment is shown. The method involves detecting a movement of a shipping container 1410, harnessing kinetic energy associated with the movement of the shipping container 1420, and converting the kinetic energy into electric power 1430. Method 1400 further involves routing the electric power to an energy storage device 1440 and storing the electric power in the energy storage device 1450. In an embodiment, this electric power is provided to an electronic device located adjacent to the shipping container.

In one example, method 1400 is expanded so as to further involve altering a magnetic field in response to the movement of the shipping container and generating the aforementioned electric power in response to the altering of the magnetic field. In a second example, method 1400 further involves coupling an energy captor with the shipping container such that the energy captor moves relative to the shipping container in response to the movement of the container, and transferring mechanical energy associated with such movement to an electric power generator. Indeed, in an embodiment, method 1400 involves utilizing an EAP device to harness the kinetic energy associated with the movement of the shipping container, utilizing the EAP device to generate a voltage differential in response to this kinetic energy, and utilizing this voltage differential to send electric power to the energy storage device.

In an alternative embodiment, method 1400 further involves utilizing a weight of the shipping container to drive a motion of a rack and pinion assembly, and transferring mechanical energy from the rack and pinion assembly to an electric power generator. Consider the example where the shipping container is lifted relative to a ground plane, and a moveable member extends from the shipping container in response to this lifting. Energy associated with the extension of the moveable member could then be transferred to the rack and pinion assembly, which would in turn transfer mechanical energy to the electric power generator. Moreover, in one embodiment, method 1400 involves lowering the shipping container from a first position above a ground plane to a second position above the ground plane, retracting a moveable member relative to the shipping container in response to the lowering, and transferring energy associated with the retracting to the rack and pinion assembly.

Therefore, an embodiment provides that kinetic energy is harnessed by means of a moveable member both during the lifting and lowering of a shipping container. However, the spirit and scope of the present technology is not limited to vertical movements of a shipping container. Indeed, as explained above, many possibilities exist for moving a shipping containers in various different directions, and with different types and degrees of forces, while simultaneously sensing and harnessing kinetic energy associated with such movements.

Thus, exemplary embodiments have been provided herein wherein electric power is generated using a motion of a shipping container. Various embodiments described herein would not be obvious at least because such embodiments utilize a specific amount of potential energy associated with a weight of such a container. Various other embodiments would not be obvious at least because kinetic energy is captured in response to specific energy capture configurations, such as when an eccentric mass rotates about a vertical axis of rotation, or when vibrations associated with a movement of the container are captured using a vibration-sensitive membrane, such as an EAP membrane.

Although various embodiments discussed herein are described in the context of a moveable cargo or shipping container, the embodiments described herein may also be implemented using a different type of conveyance device. Indeed, the spirit and scope of the present technology is not limited to the use of moveable cargo or shipping containers. For example, various embodiments described herein may be implemented with any type of moving unit wherein the movement of such unit involves an amount of kinetic energy that may be captured.

Moreover, although various electric, mechanical and electrochemical systems are discussed herein, these systems are presented as exemplary implementations, and are not intended to suggest any limitation as to the scope of use or functionality of the present technology. Neither should such systems be interpreted as having any dependency or relation to any one or combination of components illustrated in the disclosed examples.

In addition, one or more operations of various embodiments of the present technology may be controlled or implemented using computer-executable instructions, such as program modules, being executed by a computer. Generally, program modules include routines, programs, objects, components, data structures, etc., that perform particular tasks or implement particular abstract data types. In addition, the present technology may also be practiced in distributed computing environments where tasks are performed by remote processing devices that are linked through a communications network. In a distributed computing environment, program modules may be located in both local and remote computer-storage media including memory-storage devices.

### Example Computer System Environment

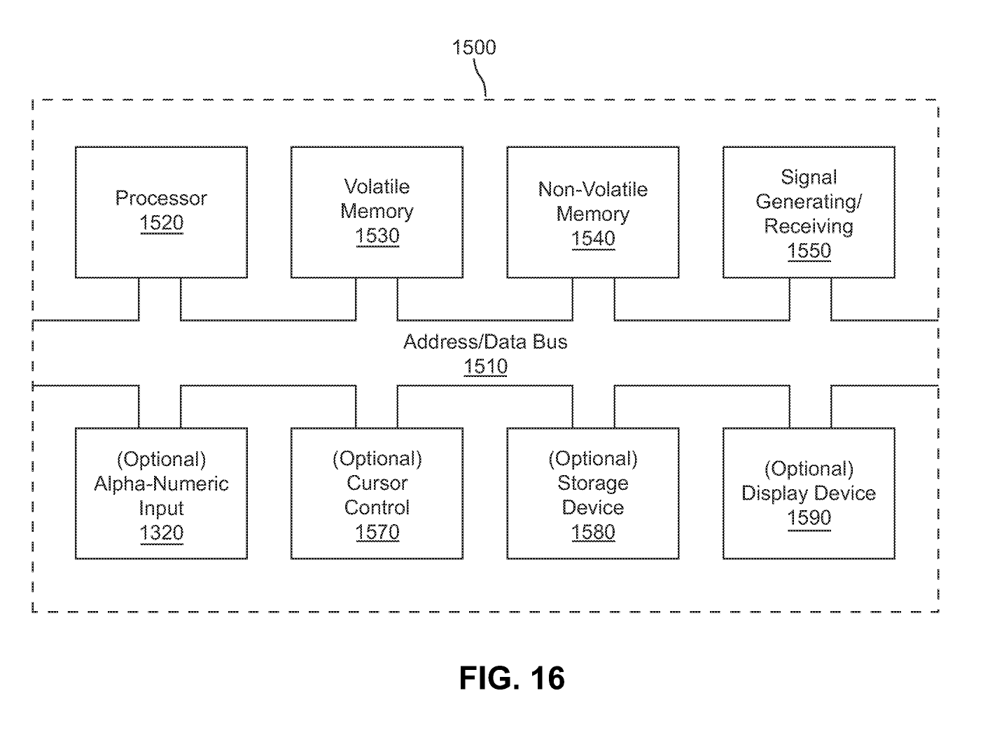

With reference now to FIG. 16, an exemplary computer system 1500 used in accordance with an embodiment is shown. Computer system 1500 may be well suited to be any type of computing device (e.g., a computing device utilized to perform calculations, processes, operations, and functions associated with a program or algorithm). Within the discussions herein, certain processes and steps are discussed that are realized, pursuant to one embodiment, as a series of instructions, such as a software program, that reside within computer readable memory units and are executed by one or more processors of computer system 1500. When executed, the instructions cause computer system 1500 to perform specific actions and exhibit specific behavior described in various embodiments herein.

With reference still to FIG. 16, computer system 1500 includes an address/data bus 1510 for communicating information. In addition, one or more central processors, such as central processor 1520, are coupled with address/data bus 1510, wherein central processor 1520 is used to process information and instructions. In an embodiment, central processor 1520 is a microprocessor. However, the spirit and scope of the present technology is not limited to the use of microprocessors for processing information. Indeed, pursuant to one example, central processor 1520 is a processor other than a microprocessor.

Computer system 1500 further includes data storage features such as a computer-usable volatile memory unit 1530, wherein volatile memory unit 1530 is coupled with address/data bus 1510 and used to store information and instructions for central processor 1520. In an embodiment, volatile memory unit 1530 includes random access memory (RAM), such as static RAM and/or dynamic RAM. Moreover, computer system 1500 also includes a computer-usable non-volatile memory unit 1540 coupled with address/data bus 1510, wherein non-volatile memory unit 1540 stores static information and instructions for central processor 1520. In an embodiment, non-volatile memory unit 1540 includes read-only memory (ROM), such as programmable ROM, flash memory, erasable programmable ROM (EPROM), and/or electrically erasable programmable ROM (EEPROM). The foregoing notwithstanding, the present technology is not limited to the use of the exemplary storage units discussed herein. Indeed, other types of memory may also be implemented.

With reference still to FIG. 16, computer system 1500 also includes one or more signal generating and receiving devices 1550 coupled with address/data bus 1510 for enabling computer system 1500 to interface with other electronic devices and computer systems. The communication interface(s) implemented by one or more signal generating and receiving devices 1550 may include wired (e.g., serial cables, modems, and network adaptors) and/or wireless (e.g., wireless modems and wireless network adaptors) communication technology.

In an embodiment, computer system 1500 includes an optional alphanumeric input device 1560 coupled with address/data bus 1510, wherein optional alphanumeric input device 1560 includes alphanumeric and function keys for communicating information and command selections to central processor 1520. Moreover, pursuant to one embodiment, an optional cursor control device 1570 is coupled with address/data bus 1510, wherein optional cursor control device 1570 is used for communicating user input information and command selections to central processor 1520. Consider the example where optional cursor control device 1570 is implemented using a mouse, a track-ball, a track-pad, an optical tracking device, or a touch screen. In a second example, a cursor is directed and/or activated in response to input from optional alphanumeric input device 1560, such as when special keys or key sequence commands are executed. In an alternative embodiment, however, a cursor is directed by other means, such as, for example, voice commands.

With reference still to FIG. 16, computer system 1500, pursuant to one embodiment, includes an optional computer-usable data storage device 1580 coupled with address/data bus 1510, wherein optional computer-usable data storage device 1580 is used to store information and/or computer executable instructions. In an example, optional computer-usable data storage device 1580 is a magnetic or optical disk drive, such as a hard drive, floppy diskette, compact disk-ROM (CD-ROM), or digital versatile disk (DVD).

Furthermore, in an embodiment, an optional display device 1590 is coupled with address/data bus 1510, wherein optional display device 1590 is used for displaying video and/or graphics. In one example, optional display device 1590 is a cathode ray tube (CRT), liquid crystal display (LCD), field emission display (FED), plasma display or any other display device suitable for displaying video and/or graphic images and alphanumeric characters recognizable to a user.

Computer system 1500 is presented herein as an exemplary computing environment in accordance with an embodiment. However, computer system 1500 is not strictly limited to being a computer system. For example, an embodiment provides that computer system 1500 represents a type of data processing analysis that may be used in accordance with various embodiments described herein. Moreover, other computing systems may also be implemented. Indeed, the spirit and scope of the present technology is not limited to any single data processing environment.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An electric power generator for use in recharging a storage cell, said electric power generator comprising:
an energy captor coupled with a shipping container, said energy captor configured to capture energy from a motion of said shipping container;
an energy converter coupled with said energy captor, said energy converter configured to generate electric power from said captured energy; and
a power projector coupled with said energy converter, said power projector configured to send said electric power to a storage cell.

2. The electric power generator of claim 1, wherein said energy captor is a wave energy captor selected from a group consisting of a pitch generator, a roll generator, a yaw generator, and a heave generator.

3. The electric power generator of claim 1, wherein said energy captor is a pendulum module comprising:
a pendulum moveably coupled with said shipping container such that a position of said pendulum relative to said shipping container changes in response to a motion of said shipping container, and such that a magnetic field is generated in response to a change in said position, said electric power being generated in response to a generation of said magnetic field.

4. The electric power generator of claim 1, wherein said energy captor is an electroactive polymer (EAP) device comprising:
a plurality of electrodes; and
an electroactive polymer (EAP) film coupled with said plurality of electrodes, said EAP film configured to move in response to said motion of said shipping container such that a movement of said EAP film induces a voltage differential across said pair of electrodes.

5. The electric power generator of claim 1, wherein said energy captor is an acoustic module comprising:
a support element; and
an acoustic membrane coupled with said support element, said acoustic membrane configured to respond to a vibration associated with a movement of said shipping container and move in response to said vibration.

6. The electric power generator of claim 5, wherein said acoustic module further comprises:
a stiffening element coupled with said acoustic membrane, said stiffening element configured to stretch a surface area of said acoustic membrane such that said acoustic membrane is configured to vibrate within a specific frequency range.

7. The electric power generator of claim 5, wherein said acoustic membrane is an electroactive polymer (EAP) membrane, and wherein said energy converter comprises a plurality of electrodes coupled with said electroactive polymer (EAP) membrane such that a movement of said electroactive polymer (EAP) membrane in response to said vibration induces a voltage differential between said plurality of electrodes.

8. The electric power generator of claim 1, wherein said energy captor is a retractable member assembly comprising:
a rack and pinion assembly; and
a retractable member operatively coupled with said rack and pinion assembly such that an operation of said retractable member drives a movement of said rack and pinion assembly, said movement being utilized to transfer mechanical energy to said energy converter.

9. The electric power generator of claim 8, further comprising:
a shock absorbing element operatively coupled with said retractable member such that a tension of said shock absorbing element controls the rate at which said retractable member extends and retracts.

10. A method of generating electric power comprising:
detecting a movement of a shipping container;
harnessing kinetic energy associated with said movement;
converting said kinetic energy into electric power;
routing said electric power to an energy storage device; and
storing said electric power in said energy storage device.

11. The method of claim 10, further comprising:
altering a magnetic field in response to said movement; and
generating said electric power in response to said altering of said magnetic field.

12. The method of claim 10, wherein said harnessing further comprises:
coupling an energy captor with said shipping container such that said energy captor moves relative to said shipping container in response to said movement; and
transferring mechanical energy associated with said movement to an electric power generator.

13. The method of claim 10, further comprising:
utilizing a weight of said shipping container to drive a motion of a motion translation device; and
transferring mechanical energy from said motion translation device to an electric power generator.

14. The method of claim 13, further comprising:
lifting said shipping container relative to a ground plane;
extending a moveable member from said shipping container in response to said lifting; and
transferring energy associated with said extending to said motion translation device.

15. The method of claim 13, further comprising:
lowering said shipping container from a first position above a ground plane to a second position above said ground plane;
retracting a moveable member relative to said shipping container in response to said lowering; and
transferring energy associated with said retracting to said motion translation device.

16. The method of claim 10, further comprising:
utilizing an electroactive polymer (EAP) device to harness said kinetic energy;
utilizing said EAP device to generate a voltage differential in response to said kinetic energy; and
utilizing said voltage differential to send said electric power to said energy storage device.

17. The method of claim 10, further comprising:
providing said electric power to an electronic device located adjacent to said shipping container.

18. An electric power generator comprising:
an acoustic module configured to capture energy associated with a physical movement, said acoustic module comprising an acoustic membrane coupled with a support element, said acoustic membrane configured to sense a vibration associated with said physical movement and move in response to said vibration;
an energy converter coupled with said acoustic module, said energy converter configured to receive said captured energy and convert said captured energy into electric power; and
a power projector coupled with said energy converter, said power projector configured to route said electric power to a target device.

19. The electric power generator of claim 18, wherein said vibration results from a movement of a physical object with which the acoustic module is coupled.

20. The electric power generator of claim 18, wherein said vibration results from a change in air pressure, and wherein said acoustic membrane is configured to sense said change in air pressure.

21. The electric power generator of claim 18, wherein said acoustic module further comprises:
a stiffening element coupled with said acoustic membrane, said stiffening element configured to stretch a surface area of said acoustic membrane such that said acoustic membrane is configured to vibrate within a specific frequency range.

22. The electric power generator of claim 18, wherein said acoustic membrane is an electroactive polymer (EAP) membrane, and wherein said energy converter comprises a plurality of electrodes coupled with said electroactive polymer (EAP) membrane such that a movement of said electroactive polymer (EAP) membrane in response to said vibration induces a voltage differential between said plurality of electrodes.

23. A shipping container comprising:
a retractable member moveably coupled with said shipping container such that a portion of said retractable member is configured to retract toward said shipping container in response to a first force and extend away from said shipping container in response to a second force;
an energy converter coupled with said retractable member, said energy converter configured to receive mechanical energy associated with a movement of said retractable member relative to said shipping container and convert said mechanical energy into electric power; and
a power projector coupled with said energy converter, said power projector configured to route said electric power to a target device adjacent to said shipping container.

24. The shipping container of claim 23 further comprising:
a rack and pinion assembly coupled between said retractable member and said energy converter, said rack and pinion assembly configured to transfer said mechanical energy from said retractable member to said energy converter.

25. The shipping container of claim 23, further comprising:
a shock absorbing element operatively coupled with said retractable member such that a tension of said shock absorbing element controls the rate at which said retractable member extends and retracts.
